(19) United States
(12) Patent Application Publication
(10) Pub. No.: US 2021/0406765 A1
(43) Pub. Date: Dec. 30, 2021

(54) PARTIALLY-OBSERVED SEQUENTIAL VARIATIONAL AUTO ENCODER

(71) Applicant: Microsoft Technology Licensing, LLC, Redmond, WA (US)

(72) Inventors: Cheng ZHANG, Cambridge (GB); Yingzhen LI, Cambridge (GB); Sebastian TSCHIATSCHEK, Cambridge (GB); Haiyan YIN, Cambridge (GB); Jooyeon KIM, Cambridge (GB)

(21) Appl. No.: 17/002,771

(22) Filed: Aug. 25, 2020

(30) Foreign Application Priority Data
Jun. 30, 2020 (GB) 2009983.4

(51) Int. Cl. G06N 20/00; G06N 5/02

(52) U.S. Cl. CPC G06N 20/00; G06N 5/022

(57) ABSTRACT

A computer-implemented method of training a model comprising a sequence of stages, each stage in the sequence comprises: a VAE comprising a respective first encoder arranged to encode a respective subset of the real-world features into a respective latent space representation, and a respective first decoder arranged to decode from the respective latent space representation to a respective decoded version of the respective set of real-world features; at least each but the last stage in the sequence comprises: a respective second decoder arranged to decode from the respective latent space representation to predict one or more respective actions; and each successive stage in the sequence following the first stage, each succeeding a respective preceding stage in the sequence, further comprises: a sequential network arranged to transform from the latent representation from the preceding stage to the latent space representation of the successive stage.

### BACKGROUND

Neural networks are used in the field of machine learning and artificial intelligence (AI). A neural network comprises plurality of nodes which are interconnected by links, sometimes referred to as edges. The input edges of one or more nodes form the input of the network as a whole, and the output edges of one or more other nodes form the output of the network as a whole, whilst the output edges of various nodes within the network form the input edges to other nodes. Each node represents a function of its input edge(s) weighted by a respective weight, the result being output on its output edge(s). The weights can be gradually tuned based on a set of experience data (training data) so as to tend towards a state where the network will output a desired value for a given input.

Typically the nodes are arranged into layers with at least an input and an output layer. A “deep” neural network comprises one or more intermediate or “hidden” layers in between the input layer and the output layer. The neural network can take input data and propagate the input data through the layers of the network to generate output data. Certain nodes within the network perform operations on the data, and the result of those operations is passed to other nodes, and so on.

FIG. 1A gives a simplified representation of an example neural network 101 by way of illustration. The example neural network comprises multiple layers of nodes 104: an input layer 102i, one or more hidden layers 102h and an output layer 102o. In practice, there may be many nodes in each layer, but for simplicity only a few are illustrated. Each node 104 is configured to generate an output by carrying out a function on the values input to that node. The inputs to one or more nodes form the input of the neural network, the outputs of some nodes form the inputs to other nodes, and the outputs of one or more nodes form the output of the network.

At some or all of the nodes of the network, the input to that node is weighted by a respective weight. A weight may define the connectivity between a node in a given layer and the nodes in the next layer of the neural network. A weight can take the form of a single scalar value or can be modelled as a probabilistic distribution. When the weights are defined by a distribution, as in a Bayesian model, the neural network can be fully probabilistic and captures the concept of uncertainty. The values of the connections 106 between nodes may also be modelled as distributions. This is illustrated schematically in FIG. 1B. The distributions may be represented in the form of a set of samples or a set of parameters parameterizing the distribution (e.g. the mean μ and standard deviation σ or variance σ²).

The network learns by operating on data input at the input layer, and adjusting the weights applied by some or all of the nodes based on the input data. There are different learning approaches, but in general there is a forward propagation through the network from left to right in FIG. 1A, a calculation of an overall error, and a backward propagation of the error through the network from right to left in FIG. 1A. In the next cycle, each node takes into account the back propagated error and produces a revised set of weights. In this way, the network can be trained to perform its desired operation.

The input to the network is typically a vector, each element of the vector representing a different corresponding feature. E.g. in the case of image recognition the elements of this feature vector may represent different pixel values, or in a medical application the different features may represent different symptoms or patient questionnaire responses. The output of the network may be a scalar or a vector. The output may represent a classification, e.g. an indication of whether a certain object such as an elephant is recognized in the image, or a diagnosis of the patient in the medical example.

FIG. 1C shows a simple arrangement in which a neural network is arranged to predict a classification based on an input feature vector. During a training phase, experience data comprising a large number of input data points X is supplied to the neural network, each data point comprising an example set of values for the feature vector, labelled with a respective corresponding value of the classification Y. The classification Y could be a single scalar value (e.g. representing elephant or not elephant), or a vector (e.g. a one-hot vector whose elements represent different possible classification results such as elephant, hippopotamus, rhinoceros, etc.). The possible classification values could be binary or could be soft-values representing a percentage probability. Over many example data points, the learning algorithm tunes the weights to reduce the overall error between the labelled classification and the classification predicted by the network. Once trained with a suitable number of data points, an unlabeled feature vector can then be input to the neural network, and the network can instead predict the value of the classification based on the input feature values and the tuned weights.

Training in this manner is sometimes referred to as a supervised approach. Other approaches are also possible, such as a reinforcement approach wherein the network each data point is not initially labelled. The learning algorithm begins by guessing the corresponding output for each point, and is then told whether it was correct, gradually tuning the weights with each such piece of feedback. Another example is an unsupervised approach where input data points are not labelled at all and the learning algorithm is instead left to infer its own structure in the experience data. The term “training” herein does not necessarily limit to a supervised, reinforcement or unsupervised approach.

A machine learning model (also known as a “knowledge model”) can also be formed from more than one constituent neural network. An example of this is an auto encoder, as illustrated by way of example in FIGS. 4A-D. In an auto encoder, an encoder network is arranged to encode an observed input vector Xₒ into a latent vector Z, and a decoder network is arranged to decode the latent vector back into the real-world feature space of the input vector. The difference between the actual input vector Xₒ and the version of the input vector \hat{X} predicted by the decoder is used to tune the weights of the encoder and decoder so as to minimize a measure of overall difference, e.g. based on an evidence lower bound (ELBO) function. The latent vector Z can be thought of as a compressed form of the information in the input feature space. In a variational auto encoder (VAE), each element of the latent vector Z is modelled as a probabilistic or statistical distribution such as a Gaussian. In this case, for each element of Z the encoder learns one or more parameters of the distribution, e.g. a measure of centre point and spread of the distribution. For instance the centre point could be the mean and the spread could be the variance or standard deviation. The value of the element input to the decoder is then randomly sampled from the learned distribution.

The encoder is sometimes referred to as an inference network in that it infers the latent vector Z from an input observation Xₒ. The decoder is sometimes referred to as a generative network in that it generates a version \hat{X} of the input feature space from the latent vector Z.

Once trained, the auto encoder can be used to impute missing values from a subsequently observed feature vector Xₒ. Alternatively or additionally, a third network can be trained to predict a classification Y from the latent vector, and then once trained, used to predict the classification of a subsequent, unlabeled observation.

### SUMMARY

Machine learning models have been used previously for automated sequential decision making, e.g. in the field of visual recognition, robotics control, medical diagnosis and computer games. These previous models are typically trained on large amounts of data with a fixed set of available features and when deployed they are assumed to operate on data with the same features. However, in many real-world applications, the fundamental assumption that the same features are readily available during deployment does not hold. Conventional VAEs of this type therefore do not perform as well as required, or desired, when only groups of the training data are available for measurement, i.e. observation.

Moreover, it would also be desirable that the model is able to operate on different sets of features. For instance, consider a medical support system for monitoring and treating patients during their stay at hospital which was trained on rich historical medical data. To provide the best possible treatment, the system might need to perform several measurements of the patient over time. However, some of these measurements could be costly to perform or pose a health risk. That is, at the deployment, it would be preferable for the system to be able to function with minimal and carefully selected features while during training more features might have been available.

It would therefore be desirable to be able to deploy a decision-making model that takes the measurement process, i.e., feature acquisition, into account and only acquires the information relevant for making a decision.

According to one aspect disclosed herein, there is provided a computer-implemented method of training a model comprising a sequence of stages from a first stage to a last stage in the sequence, the model being trained based on i) a set of real-world features of a feature space associated with a target that are available for observation, and ii) a set of actions that are available to apply to the target, wherein the set of actions comprises observing at least one of the set of real-world features, and/or performing at least one task in order to affect a status of the target, wherein the model is trained to achieve a desired outcome, and wherein: each stage in the sequence comprises: a variational auto-encoder, VAE, comprising a respective first encoder arranged to encode a respective subset of the real-world features into a respective latent space representation, and a respective first decoder arranged to decode from the respective latent space representation to a respective decoded version of the respective set of real-world features; at least each but the last stage in the sequence comprises: a respective second decoder arranged to decode from the respective latent space representation to predict one or more respective actions; and each successive stage in the sequence following the first stage, each succeeding a respective preceding stage in the sequence, further comprises: a sequential network arranged to transform from the latent representation from the preceding stage to the latent space representation of the successive stage.

For example, in a medical setting, the target may be a human patient and the real-world features may comprise characteristics of the patient. Some features may be categorical values (e.g. a yes/no answer to a questionnaire, or gender). Other features may be continuous numerical values (e.g. height, temperature, weight, etc.). The desired outcome of the patient may be achieved a desired health status, and achieving the health status may include applying a course of treatment actions to treat a disease, or other form of medical condition. At least some of the stages in the sequence predict one or more actions (i.e. one or more actions are selected), that are to be applied to the patient. For instance, an action may involve making an observation of the patient, e.g. test the patient's body temperature, pH level, or blood pressure. Or, an action may involve applying a treatment to the patient, e.g. supply antibiotics, putting the patient on a ventilator, or performing a surgical operation.

The sequential model of the present invention extends over static, end-to-end models in two ways. First, decisions are made at each stage to influence the acquisition of new features and/or the performance of tasks. Secondly, the decisions made at each stage are stage-dependent (e.g. time dependent). That is, the decisions are a function of the stage of the model at which a decision is being made (e.g. a decision made today may be based on the state of the target yesterday). The stage-dependency is a result of the transformation of a preceding latent space representation to a present latent space representation.

The model is trained to learn which actions to take at which stage in order to achieve a desired outcome. Put another way, at each stage the model answers the question of “what type of action should be taken in order to progress towards the outcome?” The actions chosen may be a trade-off between the positive reward gained from the action and the negative cost of taking the action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1A is a schematic illustration of a neural network,

FIG. 1B is a schematic illustration of a node of a Bayesian neural network,

FIG. 1C is a schematic illustration of a neural network arranged to predict a classification based on an input feature vector,

FIG. 2 is a schematic illustration of a computing apparatus for implementing a neural network,

FIG. 3 schematically illustrates a data set comprising a plurality of data points each comprising one or more feature values,

FIG. 4A is a schematic illustration of a variational auto encoder (VAE),

FIG. 4B is another schematic representation of a VAE,

FIG. 4C is a high-level schematic representation of a VAE,

FIG. 4D is a high-level schematic representation of a VAE,

FIG. 5A schematically illustrates a machine learning model in accordance with embodiments disclosed herein,

FIG. 5B also schematically illustrates a machine learning model in accordance with embodiments disclosed herein,

FIG. 5C schematically illustrates a machine learning model in accordance with some embodiments disclosed herein,

FIG. 5D also schematically illustrates a machine learning model in accordance with some embodiments disclosed herein,

FIG. 5E also schematically illustrates a machine learning model in accordance with some embodiments disclosed herein,

FIG. 6 is a flow chart of an overall method in accordance with the presently disclosed techniques,

FIG. 7 is schematically illustrating a more detailed version of the model, and

FIG. 8 shows performance curves on the bouncing ball+ domain, where (a) shows episodic number of observations; (b) shows task rewards w/o cost; and (c) shows an ablation study on bouncing ball+ to illustrate the effect of learning the feature acquisition policy.

FIG. 9 shows a Seq-PO-VAE reconstruction for the online trajectories upon convergence, where each block of three rows corresponds to the results for one trajectory. In each block, the three rows (top-down) correspond to: (1) the partially observable input selected by acquisition policy; (2) the ground-truth full observation; (3) reconstruction from Seq-PO-VAE. The boxes remark the frames where ball is not observed but our model could impute its location.

FIGS. 10 (a), (b), and (c) show performance curves in terms of discharge rate, mortality rate and reward (w/o cost) for the compared approaches on Sepsis. The curves are derived under cost value of 0.01.

FIG. 11 shows a plot of active feature acquisition (under different cost values) vs. random feature acquisition.

FIG. 12 shows a plot of total feature acquisition cost consumed by different approaches.

### DETAILED DESCRIPTION OF EMBODIMENTS

At a high level, it would be desirable for a model to solve the challenging problem of learning effective policies when the cost of information acquisition cannot be neglected. For such a model to be successful, the model must learn policies which acquire the information required for solving a task in the most cost-efficient way. The inventors of the present invention have recognised that a successful model broadly relies on two policies: an acquisition policy which selects the features to be observed, and a task policy which selects actions to change the state of the system towards some goal. As a consequence, these two policies are intimately connected, i.e., the acquisition policy must collect features such that the task policy can take good actions, and the task policy needs to enable the acquisition policy to collect informative features by transiting to appropriate states.

The task policy of the model is based upon groups of features only, i.e., there are missing features, where the missingness is controlled by the acquisition policy. Thus, the resulting model is different from conventional models in the re-enforcement learning field where the partial observability stems from a fixed and action independent observation model. Also, the state-transitions in conventional models are often only determined by the choice of the task action, whereas in the present model the state-transition is affected by both the task action and the feature acquisition choice.

The learning of the acquisition policy introduces an additional dimension to the explore-exploit problem: each execution of the acquisition and task policy needs to solve an explore-exploit problem. Most reinforcement learning research has not taken active feature acquisition into consideration. The present model improves on previous approaches by using a unified approach that jointly learns a policy for optimizing the task reward while performing active feature acquisition. Although some of the prior works have exploited the use of reinforcement learning for sequential feature acquisition tasks, they considered variable-wise information acquisition in a static setting only, corresponding to feature selection for non-time-dependent prediction tasks. However, the present model may be truly time-dependent since feature acquisitions may need to be made at each time step while the state of the system evolves simultaneously. As such, both the model dynamics and the choice of feature acquisition introduce considerable challenges to learning the sequential feature acquisition strategy.

Due to the challenge of the exploration-exploitation problem, it is a non-trivial task to jointly learn the policies. The conventional end-to-end approaches often result in inferior solutions in complex scenarios. Ideally, policies based on high-quality representations would be easier for the algorithm to search for better solutions through exploration-exploitation. Therefore, as discussed below, the present techniques also tackle the joint policy training task from a representation learning perspective. Specifically, a novel sequential generative model is used to not only encode the partially observed information, but also efficiently learns to impute the unobserved features to offer more meaningful information for the policy training. In summary, the present model considers both active learning for time-dependent sequential decision-making tasks together with model-based representation learning.

Thus there is provided an improved model for automated decision making which alleviates the limitations of conventional models.

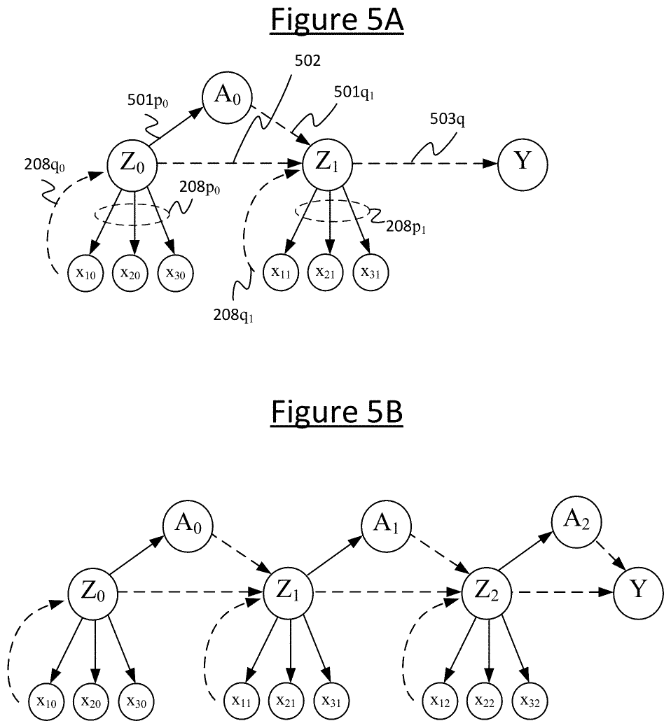

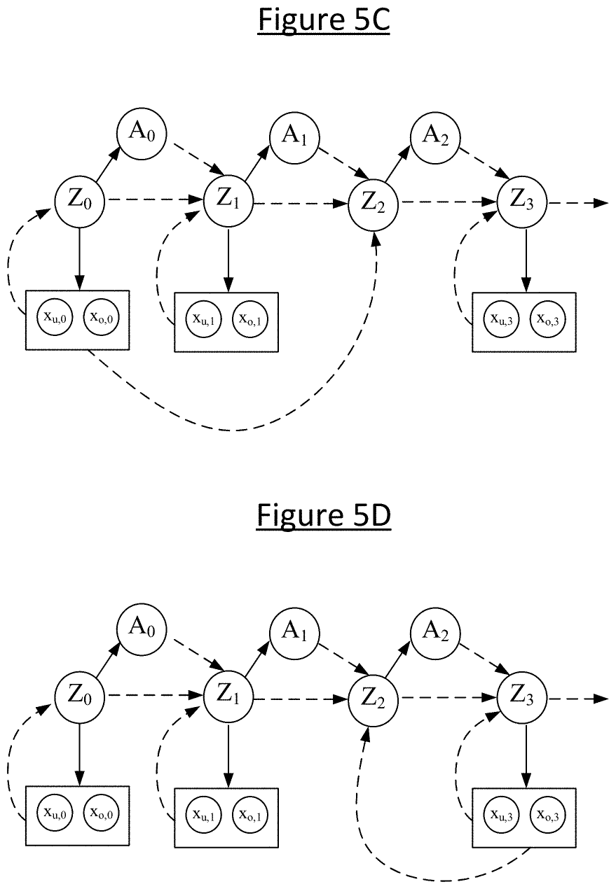

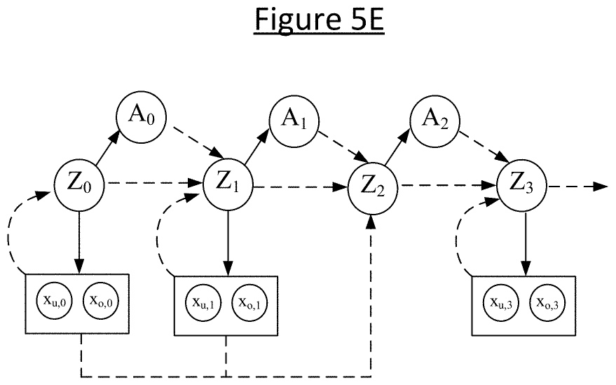

The novel model of the present application will be discussed in more detail shortly with reference to FIG. 5A onwards. First however a general overview of neural networks and their use in VAEs will is discussed with reference to FIGS. 2 to 4D.

FIG. 2 illustrates an example computing apparatus 200 for implementing an artificial intelligence (AI) algorithm including a machine-learning (ML) model in accordance with embodiments described herein. The computing apparatus 200 may comprise one or more user terminals, such as a desktop computer, laptop computer, tablet, smartphone, wearable smart device such as a smart watch, or an on-board computer of a vehicle such as car, etc. Additionally or alternatively, the computing apparatus 200 may comprise a server. A server herein refers to a logical entity which may comprise one or more physical server units located at one or more geographic sites. Where required, distributed or “cloud” computing techniques are in themselves known in the art. The one or more user terminals and/or the one or more server units of the server may be connected to one another via a packet-switched network, which may comprise for example a wide-area internetwork such as the Internet, a mobile cellular network such as a 3GPP network, a wired local area network (LAN) such as an Ethernet network, or a wireless LAN such as a Wi-Fi, Thread or 6LoWPAN network.

The computing apparatus 200 comprises a controller 202, an interface 204, and an artificial intelligence (AI) algorithm 206. The controller 202 is operatively coupled to each of the interface 204 and the AI algorithm 206.

Each of the controller 202, interface 204 and AI algorithm 206 may be implemented in the form of software code embodied on computer readable storage and run on processing apparatus comprising one or more processors such as CPUs, work accelerator co-processors such as GPUs, and/or other application specific processors, implemented on one or more computer terminals or units at one or more geographic sites. The storage on which the code is stored may comprise one or more memory devices employing one or more memory media (e.g. electronic or magnetic media), again implemented on one or more computer terminals or units at one or more geographic sites. In embodiments, one, some or all the controller 202, interface 204 and AI algorithm 206 may be implemented on the server. Alternatively, a respective instance of one, some or all of these components may be implemented in part or even wholly on each of one, some or all of the one or more user terminals. In further examples, the functionality of the above-mentioned components may be split between any combination of the user terminals and the server. Again it is noted that, where required, distributed computing techniques are in themselves known in the art. It is also not excluded that one or more of these components may be implemented in dedicated hardware.

The controller 202 comprises a control function for coordinating the functionality of the interface 204 and the AI algorithm 206. The interface 204 refers to the functionality for receiving and/or outputting data. The interface 204 may comprise a user interface (UI) for receiving and/or outputting data to and/or from one or more users, respectively; or it may comprise an interface to one or more other, external devices which may provide an interface to one or more users. Alternatively the interface may be arranged to collect data from and/or output data to an automated function or equipment implemented on the same apparatus and/or one or more external devices, e.g. from sensor devices such as industrial sensor devices or IoT devices. In the case of interfacing to an external device, the interface 204 may comprise a wired or wireless interface for communicating, via a wired or wireless connection respectively, with the external device. The interface 204 may comprise one or more constituent types of interface, such as voice interface, and/or a graphical user interface.

The interface 204 is thus arranged to gather observations (i.e. observed values) of various features of an input feature space. It may for example be arranged to collect inputs entered by one or more users via a UI front end, e.g. microphone, touch screen, etc.; or to automatically collect data from unmanned devices such as sensor devices. The logic of the interface may be implemented on a server, and arranged to collect data from one or more external user devices such as user devices or sensor devices. Alternatively some or all of the logic of the interface 204 may also be implemented on the user device(s) or sensor devices its/themselves.

The controller 202 is configured to control the AI algorithm 206 to perform operations in accordance with the embodiments described herein. It will be understood that any of the operations disclosed herein may be performed by the AI algorithm 206, under control of the controller 202 to collect experience data from the user and/or an automated process via the interface 204, pass it to the AI algorithm 206, receive predictions back from the AI algorithm and output the predictions to the user and/or automated process through the interface 204.

The machine learning (ML) algorithm 206 comprises a machine-learning model 208, comprising one or more constituent neural networks 101. A machine-leaning model 208 such as this may also be referred to as a knowledge model. The machine learning algorithm 206 also comprises a learning function 209 arranged to tune the weights w of the nodes 104 of the neural network(s) 101 of the machine-learning model 208 according to a learning process, e.g. training based on a set of training data.

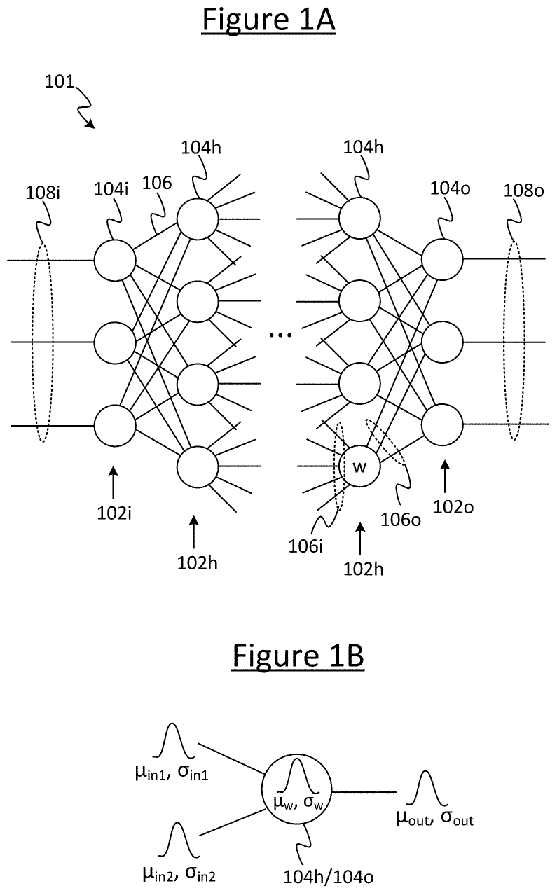

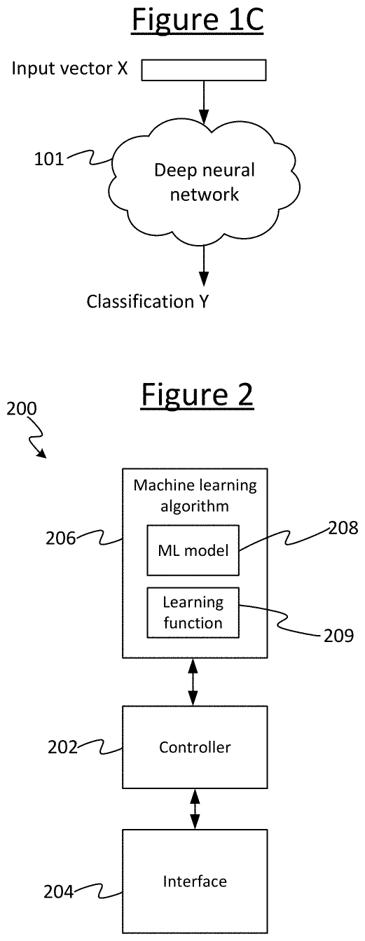

FIG. 1A illustrates the principle behind a neural network. A neural network 101 comprises a graph of interconnected nodes 104 and edges 106 connecting between nodes, all implemented in software. Each node 104 has one or more input edges and one or more output edges, with at least some of the nodes 104 having multiple input edges per node, and at least some of the nodes 104 having multiple output edges per node. The input edges of one or more of the nodes 104 form the overall input 108i to the graph (typically an input vector, i.e. there are multiple input edges). The output edges of one or more of the nodes 104 form the overall output 108o of the graph (which may be an output vector in the case where there are multiple output edges). Further, the output edges of at least some of the nodes 104 form the input edges of at least some others of the nodes 104.

Each node 104 represents a function of the input value(s) received on its input edges(s) 106i, the outputs of the function being output on the output edge(s) 106o of the respective node 104, such that the value(s) output on the output edge(s) 106o of the node 104 depend on the respective input value(s) according to the respective function. The function of each node 104 is also parametrized by one or more respective parameters w, sometimes also referred to as weights (not necessarily weights in the sense of multiplicative weights, though that is certainly one possibility). Thus the relation between the values of the input(s) 106i and the output(s) 106o of each node 104 depends on the respective function of the node and its respective weight(s).

Each weight could simply be a scalar value. Alternatively, as shown in FIG. 1B, at some or all of the nodes 104 in the network 101, the respective weight may be modelled as a probabilistic distribution such as a Gaussian. In such cases the neural network 101 is sometimes referred to as a Bayesian neural network. Optionally, the value input/output on each of some or all of the edges 106 may each also be modelled as a respective probabilistic distribution. For any given weight or edge, the distribution may be modelled in terms of a set of samples of the distribution, or a set of parameters parameterizing the respective distribution, e.g. a pair of parameters specifying its centre point and width (e.g. in terms of its mean μ and standard deviation σ or variance σ²). The value of the edge or weight may be a random sample from the distribution. The learning or the weights may comprise tuning one or more of the parameters of each distribution.

As shown in FIG. 1A, the nodes 104 of the neural network 101 may be arranged into a plurality of layers, each layer comprising one or more nodes 104. In a so-called “deep” neural network, the neural network 101 comprises an input layer 102i comprising one or more input nodes 104i, one or more hidden layers 102h (also referred to as inner layers) each comprising one or more hidden nodes 104h (or inner nodes), and an output layer 102o comprising one or more output nodes 104o. For simplicity, only two hidden layers 102h are shown in FIG. 1A, but many more may be present.

The different weights of the various nodes 104 in the neural network 101 can be gradually tuned based on a set of experience data (training data), so as to tend towards a state where the output 108o of the network will produce a desired value for a given input 108i. For instance, before being used in an actual application, the neural network 101 may first be trained for that application. Training comprises inputting experience data in the form of training data to the inputs 108i of the graph and then tuning the weights w of the nodes 104 based on feedback from the output(s) 108o of the graph. The training data comprises multiple different input data points, each comprising a value or vector of values corresponding to the input edge or edges 108i of the graph 101.

For instance, consider a simple example as in FIG. 1C where the machine-learning model comprises a single neural network 101, arranged to take a feature vector X as its input 108i and to output a classification Y as its output 108o. The input feature vector X comprises a plurality of elements x_{d}, each representing a different feature d=0, 1, 2, . . . etc. E.g. in the example of image recognition, each element of the feature vector X may represent a respective pixel value. For instance one element represents the red channel for pixel (0,0); another element represents the green channel for pixel (0,0); another element represents the blue channel of pixel (0,0); another element represents the red channel of pixel (0,1); and so forth. As another example, where the neural network is used to make a medical diagnosis, each of the elements of the feature vector may represent a value of a different symptom of the subject, physical feature of the subject, or other fact about the subject (e.g. body temperature, blood pressure, etc.).

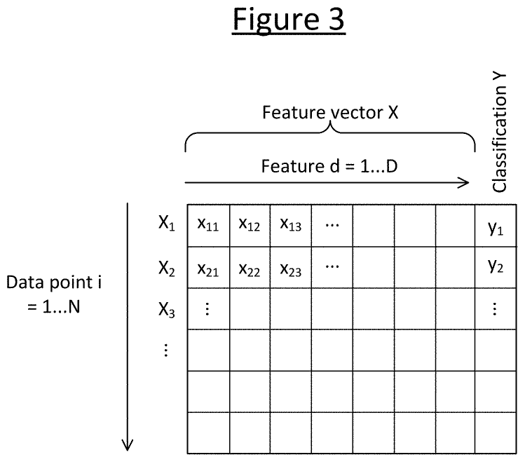

FIG. 3 shows an example data set comprising a plurality of data points i=0, 1, 2, . . . etc. Each data point i comprises a respective set of values of the feature vector (where x_{id} is the value of the dₜₕ feature in the iₜₕ data point). The input feature vector Xᵢ represents the input observations for a given data point, where in general any given observation i may or may not comprise a complete set of values for all the elements of the feature vector X. The classification Yᵢ represents a corresponding classification of the observation i. In the training data an observed value of classification Yᵢ is specified with each data point along with the observed values of the feature vector elements (the input data points in the training data are said to be “labelled” with the classification Yᵢ). In subsequent a prediction phase, the classification Y is predicted by the neural network 101 for a further input observation X.

The classification Y could be a scalar or a vector. For instance in the simple example of the elephant-recognizer, Y could be a single binary value representing either elephant or not elephant, or a soft value representing a probability or confidence that the image comprises an image of an elephant. Or similarly, if the neural network 101 is being used to test for a particular medical condition, Y could be a single binary value representing whether the subject has the condition or not, or a soft value representing a probability or confidence that the subject has the condition in question. As another example, Y could comprise a “1-hot” vector, where each element represents a different animal or condition. E.g. Y=[1, 0, 0, . . . ] represents an elephant, Y=[0, 1, 0, . . . ] represents a hippopotamus, Y=[0, 0, 1, . . . ] represents a rhinoceros, etc. Or if soft values are used, Y=[0.81, 0.12, 0.05, . . . ] represents an 81% confidence that the image comprises an image of an elephant, 12% confidence that it comprises an image of a hippopotamus, 5% confidence of a rhinoceros, etc.

In the training phase, the true value of Yᵢ for each data point i is known. With each training data point i, the AI algorithm 206 measures the resulting output value(s) at the output edge or edges 108o of the graph, and uses this feedback to gradually tune the different weights w of the various nodes 104 so that, over many observed data points, the weights tend towards values which make the output(s) 108i (Y) of the graph 101 as close as possible to the actual observed value(s) in the experience data across the training inputs (for some measure of overall error). I.e. with each piece of input training data, the predetermined training output is compared with the actual observed output of the graph 108o. This comparison provides the feedback which, over many pieces of training data, is used to gradually tune the weights of the various nodes 104 in the graph toward a state whereby the actual output 108o of the graph will closely match the desired or expected output for a given input 108i. Examples of such feedback techniques include for instance stochastic back-propagation.

Once trained, the neural network 101 can then be used to infer a value of the output 108o (Y) for a given value of the input vector 108i (X), or vice versa.

Explicit training based on labelled training data is sometimes referred to as a supervised approach. Other approaches to machine learning are also possible. For instance another example is the reinforcement approach. In this case, the neural network 101 begins making predictions of the classification Yᵢ for each data point i, at first with little or no accuracy. After making the prediction for each data point i (or at least some of them), the AI algorithm 206 receives feedback (e.g. from a human) as to whether the prediction was correct, and uses this to tune the weights so as to perform better next time. Another example is referred to as the unsupervised approach. In this case the AI algorithm receives no labelling or feedback and instead is left to infer its own structure in the experienced input data.

FIG. 1C is a simple example of the use of a neural network 101. In some cases, the machine-learning model 208 may comprise a structure of two or more constituent neural networks 101.

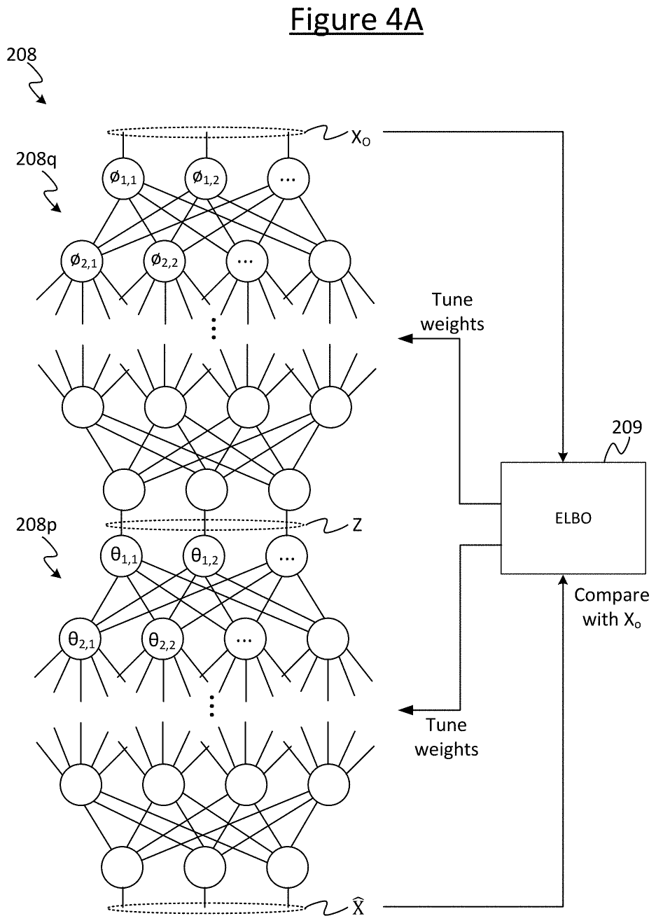

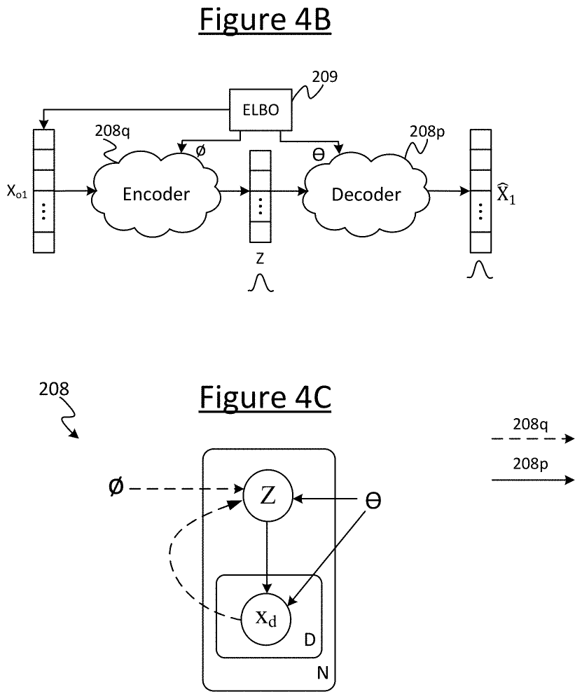

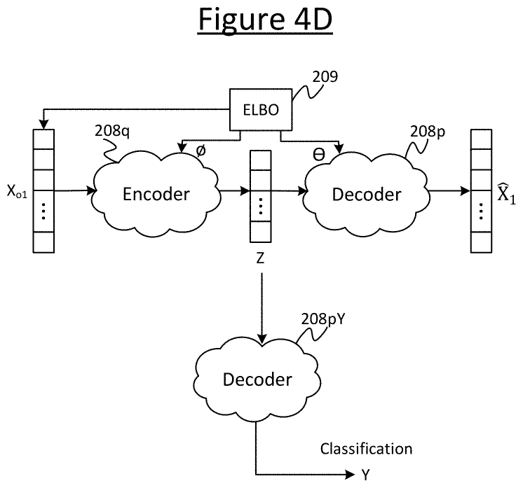

FIG. 4A schematically illustrates one such example, known as a variational auto encoder (VAE). In this case the machine learning model 208 comprises an encoder 208q comprising an inference network, and a decoder 208p comprising a generative network. Each of the inference networks and the generative networks comprises one or more constituent neural networks 101, such as discussed in relation to FIG. 1A. An inference network for the present purposes means a neural network arranged to encode an input into a latent representation of that input, and a generative network means a neural network arranged to at least partially decode from a latent representation.

The encoder 208q is arranged to receive the observed feature vector Xₒ as an input and encode it into a latent vector Z (a representation in a latent space). The decoder 208p is arranged to receive the latent vector Z and decode back to the original feature space of the feature vector. The version of the feature vector output by the decoder 208p may be labelled herein X.

The latent vector Z is a compressed (i.e. encoded) representation of the information contained in the input observations Xₒ. No one element of the latent vector Z necessarily represents directly any real world quantity, but the vector Z as a whole represents the information in the input data in compressed form. It could be considered conceptually to represent abstract features abstracted from the input data Xₒ, such as “wrinklyness” and “trunk-like-ness” in the example of elephant recognition (though no one element of the latent vector Z can necessarily be mapped onto any one such factor, and rather the latent vector Z as a whole encodes such abstract information). The decoder 208p is arranged to decode the latent vector Z back into values in a real-world feature space, i.e. back to an uncompressed form \hat{X} representing the actual observed properties (e.g. pixel values). The decoded feature vector \hat{X} has the same number of elements representing the same respective features as the input vector Xₒ.

The weights w of the inference network (encoder) 208q are labelled herein ø, whilst the weights w of the generative network (decoder) 208p are labelled θ. Each node 104 applies its own respective weight as illustrated in FIG. 4.

With each data point in the training data (each data point in the experience data during learning), the learning function 209 tunes the weights ø and θ so that the VAE 208 learns to encode the feature vector X into the latent space Z and back again. For instance, this may be done by minimizing a measure of divergence between q_{ø}(Zᵢ|Xᵢ) and p_{θ}(Xᵢ|Zᵢ), where q_{ø}(Zᵢ|Xᵢ) is a function parameterised by ø representing a vector of the probabilistic distributions of the elements of Zᵢ output by the encoder 208q given the input values of Xᵢ, whilst p_{θ}(Xᵢ|Zᵢ) is a function parameterized by θ representing a vector of the probabilistic distributions of the elements of Xᵢ output by the encoder 208q given Zᵢ. The symbol “|” means “given”. The model is trained to reconstruct Xᵢ and therefore maintains a distribution over Xᵢ. At the “input side”, the value of Xoᵢ is known, and at the “output side”, the likelihood of \hat{X}ᵢ under the output distribution of the model is evaluated. Typically p(z|x) is referred to as posterior, and q(z|x) as approximate posterior. p(z) and q(z) are referred to as priors.

For instance, this may be done by minimizing the Kullback-Leibler (KL) divergence between q_{ø}(Zᵢ|Xᵢ) and p_{θ}(Xᵢ|Zᵢ). The minimization may be performed using an optimization function such as an ELBO (evidence lower bound) function, which uses cost function minimization based on gradient descent. An ELBO function may be referred to herein by way of example, but this is not limiting and other metrics and functions are also known in the art for tuning the encoder and decoder networks of a VAE.

The requirement to learn to encode to Z and back again amounts to a constraint placed on the overall neural network 208 of the VAE formed from the constituent neural networks of the encoder and decoder 208q, 208p. This is the general principle of an autoencoder. The purpose of forcing the autoencoder to learn to encode and then decode a compressed form of the data, is that this can achieve one or more advantages in the learning compared to a generic neural network; such as learning to ignore noise in the input data, making better generalizations, or because when far away from a solution the compressed form gives better gradient information about how to quickly converge to a solution. In a variational autoencoder, the latent vector Z is subject to an additional constraint that it follows a predetermined form of probabilistic distribution such as a multidimensional Gaussian distribution or gamma distribution.

FIG. 4B shows a more abstracted representation of a VAE such as shown in FIG. 4A.

FIG. 4C shows an even higher level representation of a VAE such as that shown in FIGS. 4A and 4B. In FIG. 4C the solid lines represent a generative network of the decoder 208q, and the dashed lines represents an inference network of the encoder 208p. In this form of diagram, a vector shown in a circle represents a vector of distributions. So here, each element of the feature vector X (=x₁ . . . x_{d}) is modelled as a distribution, e.g. as discussed in relation to FIG. 1C. Similarly each element of the latent vector Z is modelled as a distribution. On the other hand, a vector shown without a circle represents a fixed point. So in the illustrated example, the weights θ of the generative network are modelled as simple values, not distributions (though that is a possibility as well). The rounded rectangle labelled N represents the “plate”, meaning the vectors within the plate are iterated over a number N of learning steps (one for each data point). In other words i=0, . . . , N−1. A vector outside the plate is global, i.e. it does not scale with the number of data points i (nor the number of features d in the feature vector). The rounded rectangle labelled D represents that the feature vector X comprises multiple elements x₁ . . . x_{d}.

There are a number of ways that a VAE 208 can be used for a practical purpose. One use is, once the VAE has been trained, to generate a new, unobserved instance of the feature vector \hat{X} by inputting a random or unobserved value of the latent vector Z into the decoder 208p. For example if the feature space of X represents the pixels of an image, and the VAE has been trained to encode and decode human faces, then by inputting a random value of Z into the decoder 208p it is possible to generate a new face that did not belong to any of the sampled subjects during training. E.g. this could be used to generate a fictional character for a movie or video game.

Another use is to impute missing values. In this case, once the VAE has been trained, another instance of an input vector Xₒ may be input to the encoder 208q with missing values. I.e. no observed value of one or more (but not all) of the elements of the feature vector Xₒ. The values of these elements (representing the unobserved features) may be set to zero, or 50%, or some other predetermined value representing “no observation.” The corresponding element(s) in the decoded version of the feature vector \hat{X} can then be read out from the decoder 208p in order to impute the missing value(s). The VAE may also be trained using some data points that have missing values of some features.

Another possible use of a VAE is to predict a classification, similarly to the idea described in relation to FIG. 1A. In this case, illustrated in FIG. 4D, a further decoder 208pY is arranged to decode the latent vector Z into a classification Y, which could be a single element or a vector comprising multiple elements (e.g. a one-hot vector). During training, each input data point (each observation of Xo) is labelled with an observed value of the classification Y, and the further decoder 208pY is thus trained to decode the latent vector Z into the classification Y. After training, this can then be used to input an unlabeled feature vector Xₒ and have the decoder 208pY generate a prediction of the classification Y for the observed feature vector Xₒ.

An improved method of forming a machine learning model 208′, in accordance with embodiments disclosed herein, is now described with reference to FIGS. 5A-5E. Particularly, the method disclosed herein is particularly suited to automated sequential decision making when only a group of features is available for observation. This machine learning (ML) model 208′ can be used in place of a standard VAE in the apparatus 200 of FIG. 2, for example, in order to make predictions, perform imputations, and make decisions. The mode 208′ will be referred to below as a “sequential model” 208′.

According to embodiments of the present invention, a sequential model 208′ comprises a sequence (i.e. series) of stages. The sequence comprises an initial stage followed by one or more successive (i.e. further) stages. In general, the initial stage receives an initial input (i.e. one or more observed features, discussed below) and makes a decision (i.e. performs a task, also discussed below). The decision is made at least in part based on the initial input, and is made in order to drive towards a desired outcome. Each of the successive stages is dependent on the state of the previous stage (e.g. a second stage is dependent on the state of the first stage). In some examples, the decision made at a given stage influences the latent state representation at the stage (e.g. an observation made at one stage affects that stage's latent space representation). In some examples, the decision made at a given stage influences the latent space representation of the succeeding stage (e.g. a task performed at a previous stage affects the present stage). Thus the sequential model is sequential in that the model is arranged to make a sequence of decisions, where the decisions made are influenced by the previously made decisions and the state of the previous stages.

In general, the sequential model may receive, as inputs, a set of features, e.g. real-world features, related to a target such as, for example a living being (e.g. a human or a different animal), or a machine (e.g. a mechanical apparatus, a computer system, etc.). At any given stage, the sequential model may receive a group of the available features. For instance, only some but not other features may be input to the model (i.e. observed). As an example, a patient's temperature may be supplied as an input. As another example, the velocity of a machine (e.g. a car) may be supplied as an input. It is also not excluded that in some examples the full set of features may be supplied as inputs. In some examples, the observed features may comprise sensor measurements that have been measured by respective sensors, and/or the observed features may comprise inputs by a human, e.g. answers to a health questionnaire.

In general, the sequential model may also output a set of actions to take in relation to the target. For instance, an action may include interacting with the target in one way or another. In some examples, performing an action may include observing one or more of the features. In other examples, performing an action may include implementing a task that affects the target, e.g. a task that physically affects the target. If the target is a living being, the task may mentally or physiologically affect the target. As a particular example, performing a task on a human may include performing a medical surgery on the human or supplying a medicament to the human. Note that outputting an action may comprise outputting a request or suggestion to perform the action, or in some examples, actually performing the action. For instance, the sequential model may be used to control a connected device that is configured to observe a measurement or perform a task, e.g. to supply a drug via an intravenous injection.

Each stage comprises a respective instance of a VAE. The VAE of each stage comprises an encoder network configured to take, as an input, one or more observed features and encode from those observed features to a latent space representation at that stage. I.e. at a first stage, a first group of one or more observed features is used by the encoder network to infer a latent space representation at that stage. The VAE of each stage also comprises a decoder network configured to decode from the latent space representation to a decoded version of the set of features (i.e. the set of observed and unobserved features). I.e. a first latent space representation at the first stage is used to generate (i.e. predict) the set of features as a whole.

Some or all of the stages also comprises a respective instance of a second decoder network. That is, those stages comprise at least two decoder networks, one that forms part of the VAE of that stage and an additional decoder network. The second decoder network of a given stage is configured to use the latent space representation at that stage to predict (i.e. generate otherwise select) one or more actions to take.

Some or all of the successive stages in the sequence (e.g. all but the initial stage) further comprises a respective instance of a second encoder network. That is, those successive stage comprise at least two encoder networks, one that forms part of the VAE of that stage and an additional decoder network. The second encoder network of a given stage is configured to encode from the predicted action(s) of the previous stage to a latent space representation of that stage. I.e. the latent space representation of a present stage is at least partly inferred based on the action(s) made by the preceding stage. In some embodiments, only predicted tasks are encoded into the latent space representation. In that case, the predicted features to observe at a present stage are used to infer the latent space representation at that present stage, i.e. the same present stage. In other words, the newly observed features are fed back into the derivation of the latent space representation at that stage.

Each successive stage in the sequence comprises a sequential network configured to transform from the latent space representation of the previous stage to the latent space representation of the present stage. That is, the latent space representation of a given successive stage is based on the latent space representation of the preceding stage.

Therefore the latent space of a given successive stage depends on (i.e. is inferred using) at least the latent space of a previous stage, and in some examples, the actions taken at the previous stage, and hence the sequential model evolves across the sequence of stages.

Note that the model may comprise more stages than those described herein. That is, the model comprises at least the described stages, the model is not limited only to these stages.

Referring first to FIG. 5A, at each stage t (t=0 . . . T) of the sequential model 208′, a respective VAE is trained for each of a set of observed features, e.g. X₁₀ and X₂₀ at stage t=0. In FIG. 5A, for a feature Xᵢₜ, i indicates the feature itself, whilst t indicates the stage at which the feature is observed or generated, as the case may be. Only three features are shown here by way of illustration, but it will be appreciated that other numbers could be used. The observed features together form a respective group of the feature space. That is, each group comprises a different respective one or more of the features of the feature space. I.e. each group is a different one or more of the elements of the observed feature vector Xₒₜ. In the example of FIG. 5A, the observed feature vector Xₒ₀ at stage 0 may comprise X₁₀ and X₂₀. An unobserved feature vector Xᵤₜ comprises those features that are not observed. In the example of FIG. 5A, the unobserved feature vector Xᵤ₀ at stage 0 may comprise X₃₀.

The features may include data whose value takes one of a discrete number of categories. An example of this could be gender, or a response to a question with a discrete number of qualitative answers. In some cases the features may categorical data could be divided into two types: binary categorical and non-binary categorical. E.g. an example of binary data would be answers to a yes/no question, or smoker/non-smoker. An example of non-binary data could be gender, e.g. male, female or other; or town or country of residence, etc. the features may include ordinal data, or continual data. An example of ordinal data would be age measured in completed years, or a response to a question giving a ranking on a scale of 1 to 10, or one or five stars, or such like. An example of continuous data would be weight or height. It will be appreciated that these different types of data have very different statistical properties.

Each feature Xᵢₜ is a single respective feature. E.g. one feature X₁ₜ could be gender, another feature X₂ₜ could be age, whilst another feature X₃ₜ could be weight (such as in an example for predicting or imputing a medical condition of a user).

The VAE of each stage t comprises a respective first encoder 208qₜ (t=0 . . . T) arranged to encode the respective observed feature Xₒₜ into a respective latent representation (i.e. latent space) Zₜ at that stage. The VAE of each stage t also comprises a respective first decoder 208pₜ (t=0 . . . T) arranged to decode the respective latent representation Zₜ back into the respective dimension(s) of the feature space of the respective group of features, i.e. to generate a decoded version \hat{X}ₜ of the respective observed feature group Xₒₜ and the unobserved feature group Xᵤₜ. For instance, the first encoder 208q₀ at stage 0 encodes from Xₒ₀ (e.g. X₁₀ and X₂₀) to Z₀, and the first decoder 208q₀ at stage 0 decodes from Z₀ to \hat{X}₀ (e.g. decoded versions of X₁₀, X₂₀ and X₃₀).

In some embodiments each of the latent representations Zₜ is one-dimensional, i.e. consists of only a single latent variable (element). Note however this does not imply the latent variable Zₜ is a modelled only as simple, fixed scalar value. Rather, as the auto-encoder is a variational auto-encoder, then for each latent variable Zₜ the encoder learns a statistical or probabilistic distribution, and the value input to the decoder is a random sample from the distribution. This means that for each individual element of latent space, the encoder learns one or more parameters of the respective distribution, e.g. a measure of centre point and spread of the distribution. For instance each latent variable Zₜ (a single dimension) may be modelled in the encoder by a respective mean value and standard deviation or variance.

However preferably each of the latent space representations Zₜ is multi-dimensional, in which case each dimension is modelled by one or more parameters of a respective distribution.

As shown in FIG. 5A, at a first successive stage t=1, the respective VAE of that stage comprises a respective first encoder 208p₁ and a respective first encoder 208q₁. The first encoder 208q₁ at stage 1 may encode from Xₒ₁ (e.g. X₂₁) to Z₁, and the first decoder 208q₀ at stage 1 decodes from Z₁ to X₁ (e.g. decoded versions of X₁₁, X₂₁ and X₃₁). Note that the observed feature vector Xₒ₁ may depend, at least in part, on the action output at stage 0, as described in more detail below.

FIG. 5A also shows at least some of the stages comprising a respective second decoder network 501pₜ. In the example of FIG. 5A only the initial stage 0 comprises a second decoder network 501p₀, whereas the successive stage (stage 1) does not comprise a second decoder network. However it is not excluded that some or all of the successive stages may comprise a respective second decoder, as is the case in FIG. 5B. It is also not essential that the initial stage 0 comprises a respective second decoder. The second decoder network 501pₜ of a given stage t is configured to predict one or more actions Aₜ based on the latent space representation Zₜ at that stage t. For instance, at stage 0, the second decoder network 501p₀ decodes from the latent space representation Z₀ to predict action(s) A₀. Any given second decoder network 501pₜ may predict a single action Aₜ or multiple actions Aₜ.

As mentioned above, the sequence of stages comprises one or more successive stages, and one some or all of those successive stages may comprise a respective second encoder network 501qₜ. The second encoder network 501qₜ is configured to encode from the predicted actions Aₜ₋₁ of the previous stage to the latent space representation Zₜ of that successive stage, i.e. the “present stage”. That is, a second encoder network 501qₜ at stage t encodes from the action(s) predicted at stage t−1 to the latent space representation Zₜ at stage t. In the example of FIG. 5A, stage 1 comprises a second encoder network 501q₀ that encodes actions(s) A₀ to the latent space representation Z₁. Each successive stage in FIG. 5A is shown as comprising a respective second encoder network 501qₜ, but it will be appreciated that this is just one of several possible implementations.

Note that when the action is to acquire a new feature, this new feature may be added to Xₒₜ, and not Xₒₜ₊₁. This means acquiring a new feature does not cause a transition of the latent state Zₜ to Zₜ₊₁, e.g. measuring the body temperature X of a patient does not make a change to the patient's health condition Z. On the other hand, if a task is performed (e.g. give a treatment), this will change the internal state and cause the transition from Zₜ to Zₜ₊₁. Therefore in this implementation, it is only the predicted tasks of a previous stage, rather than the predicted actions as a whole, that are encoded into the latent space representation of the following stage.

Each successive stage further comprises a sequential network 502 configured to transform the latent space representation Zₜ of a previous stage into a latent space representation Zₜ of a present stage. That is, stage t comprises a sequential network 502 that transforms (i.e. maps) from the latent space representation Zₜ₋₁ at stage t−1 to the latent space representation Zₜ at stage t. In the example of FIG. 5A, stage 1 comprises a sequential network 502 that transforms from latent space representation Z₀ to latent space representation Z₁. In this example, Z₁ is dependent on both Z₀ and A₀. The sequential network 502 may also be referred to as a linking network, or a latent space linking network. A linking network links (i.e. maps) one representation to another. In this case, a preceding latent space representation is linked to a succeeding latent space representation. In practice, any suitable neural network may be used as the sequential network 502.

Also shown in FIG. 5A, a final stage (i.e. a stage different from the initial and successive stages) comprises a third encoder network 503q. In some examples, as in FIG. 5A, only one third encoder network 503q is present, i.e. at the final stage. In this example, the third encoder network encodes from the latent space representation of a final stage of the sequential model to a representation of the outcome of the mode. In other examples, one, some or all of the stages of the model may also comprise a third encoder network 503qₜ. In the examples where a given stage comprises a third encoder network 503qₜ, the third encoder network 503qₜ is arranged to encode from the latent space latent space representation Zₜ of that stage to a representation of the present status Yₜ of the target. The third encoder network 503q that encodes from the final latent space representation (Z₁ in FIG. 5A) encodes to a representation of the outcome Y of the model, i.e. the final status of the target. In the context of a medical setting, the present status Yₜ of the target at a given stage may be the health status of the target at that stage. The outcome Y of the sequential model, i.e. the final status of the target, may be the final health status of the target (e.g. discharged from hospital or deceased). In some embodiments, the present status (e.g. the outcome) at stage t may be output to a user via interface 204.

Note that “final stage” does not necessarily mean that there no further stages in the model. Rather, final stage is used to refer to the final stage in the described sequence of stages. Further stages in the model as a whole are not excluded. Similarly, and for the avoidance of doubt, the “initial stage” of the sequence need not necessarily be the foremost stage of the model.

FIG. 5A can be summarised in the following way. At an initial stage 0, one or more features Xₒ₀ are observed and a respective first encoder network 208q₀ of a VAE encodes from the observed features Xₒ₀ to a latent space representation Z₀. A respective first decoder network 208p₀ of the VAE decodes from the latent space representation Z₀ to the feature space \hat{X}₀, i.e. the observed features Xₒ₀ and the unobserved features Xᵤ₀. A respective second decoder network 501p₀ decodes from the latent space representation Z₀ to predict one or more actions A₀. At a first successive stage 1, one or more features Xₒ₁ may be observed and/or a task may be performed, depending on the action(s) A₀ predicted at stage 0. The VAE at stage 1 functions in a similar way to the VAE at stage 0. Furthermore, a respective second encoder network 501q₁ encodes from the action(s) to the present latent space representation Z₁, and similarly the sequential network 502 transforms from the preceding latent space representation Z₀ from stage 0 to the present latent space representation Z₁. A third encoder network encodes from the latent space representation Z₁ at stage 1 to a final outcome Y of the model 208′.

FIG. 5B illustrates another embodiment of the sequential model 208′. The example of FIG. 5B is similar to that of FIG. 5A with the addition of an extra successive stage and several additional networks. That is, the model 208′ of FIG. 5B comprises three stages (t=1,2,3). Each stage comprises a respective VAE as described above. Each stage also comprises a respective second decoder network 501pₜ and a respective encoder network 501qₜ. Each stage also comprises a respective sequential network 502. Again, the model comprises a third encoder network 503 arranged to encode from the final latent space representation Z₂ to a final outcome Y.

FIG. 5C illustrates another embodiment of the model 208′. In this example, the decoded features \hat{X}ₜ of one stage are used by the first encoder 208qₜ of a different stage to encode the respective latent space representation Zₜ of that different stage. In FIG. 5C, the decoded features \hat{X}ₜ of an earlier stage are used by the VAE of a later stage to encode the present latent space representation Zₜ. Specifically, the decoded features \hat{X}₀ at stage 0 are used by the VAE of stage 2 to infer latent space representation Z₂.

FIG. 5D is similar to that of FIG. 5C with the exception that the decoded features \hat{X}ₜ of a later stage are used by the VAE of an earlier stage to encode the present latent space representation Zₜ.

FIG. 5E shows that the decoded features \hat{X}ₜ of multiple stages (e.g. multiple earlier stage or multiple later stages) may be used by the VAE of a particular stage. As shown in FIG. 5E, the decoded features \hat{X}₀ of stage 0 and the decoded features \hat{X}₁ of stage 1 are used by the VAE of stage 2 to infer the latent space representation Z₂. In some examples, both the decoded features \hat{X}ₜ of one or more earlier stages and the decoded features \hat{X}ₜ of one or more later stages may be used by the VAE of a particular stage.

These embodiments allow information from one or more previous stages and/or one or more future stages to be used at a different stage of the sequential model 208′ to improve the inference of the later space representation Zₜ. In other words, information from the past may be used to be more accurately determine the state of the model at a later point in time. Similarly, information from the future may be used to more accurately determine the state of the model at an earlier point in time. As shown in FIG. 5E, all of the decoded information up until a certain stage (e.g. a certain point in time) may be “re-used” to improve the belief about the system at that stage.

The sequential model 208′ is first operated in a training mode, whereby the respective networks of the model 208′ are trained (i.e. have their weights tuned) by a learning function 209 (e.g. an ELBO function). The learning function trains the model 208′ to learn which actions to take at each stage of the model 208′ in order to achieve a desired outcome, or at least drive toward a desired outcome. For instance, the model may learn which actions to take in order to improve a patient's health. The learning function comprise a reward function that is a function of the predicted outcome, e.g. a respective (positive) effect of a particular action on the predicted outcome, i.e. a reward for taking that particular action.

As mentioned above, an action may comprise acquiring more information (i.e. features) about the target or performing a task on the target. The learning function therefore learns which features to acquire and/or tasks to perform at least based on the reward associated with each feature or task. For instance, the learning function may learn to predict (i.e. choose) the action that is associated with the greatest reward. This may involve acquiring a feature that would reveal the most valuable information about the target, or performing a task that would have the most positive effect on the present status of the target, i.e. make the most progress towards the desired outcome of the model 208′.

If the chosen action is to acquire a new feature, the sequential model 208′ outputs a signal or message via the interface 204 requesting that a value of this feature is collected and returned to the algorithm 206 (being returned via the interface 204). The request may be output to a human user, who manually collects the required value and inputs it back through the interface 204 (in this case a user interface). Alternatively the request could be output to an automated process that automatically collects the requested feature and returns it via the interface. The newly collected feature may be collected as a stand-alone feature value (i.e. the collected feature is the only evaluated feature in the newly collected data point). Alternatively it could be collected along with one or more other feature values (i.e. the newly collected data point comprises a value of a plurality of features of the feature vector including the requested feature). Either way, the value of the newly collected feature(s) is/are then included amongst the observed data points in the observed data set.

Similarly, if the chosen action is to perform a task, the sequential model 208′ outputs a signal or message via the interface 204 requesting that a task is performed. The request may be output to a human user, who manually performs the task. Alternatively the request could be output to an automated process that automatically performs the task. An indication that the task has been performed may be returned to the algorithm 206 (being returned via the interface 204). Alternatively, the model 208′ may be programmed to assume that the predicted tasks are performed.

Preferably, the learning function comprises a penalty function that is a function of the cost associated with performing each action. That is, the acquisition (i.e. observation) of a new feature may be associated with a respective cost. Similarly, the performance of a task may be associated with a respective cost. It will be appreciated that some observations may be more costly than others. Similarly, some tasks may be more costly than others. For instance, the task of performing surgery on a patient may be more costly than supplying a patient with an oxygen supply, both of which may be more costly than measuring the patient's temperate or blood pressure. The cost of each action may be based on the same measurement, e.g. a risk to the patient's health, or the cost of different actions may be based on different measurements, e.g. risk, financial cost, time taken to perform the action, etc. The cost of each action may be based on several measurements.

The learning function may in general take the following form:

R=ƒ(Y)−g(Q)

Where R is the learning function, ƒ(Y) is the reward function as a function of the effect of an action on the predicted outcome Y, and g(Q) is the penalty function as a function of the cost of the action Q.

In some embodiments, the reward and/or cost of an action may be time-dependent. That is, the reward and/or cost of an action may be a function of the time at which the action is performed, or more generally, the stage of the sequential model at which the action is predicted. For instance, observing a feature may reveal more information if observed at an earlier stage compared to a later stage, or if the same feature has not been revealed for a prolonged period of time. Similarly, a task (e.g. medical procedure) may be more costly if performed on a patient who has been ill for a while compared with a patient who has been ill for a shorter period of time. The time-dependency of the reward and/or cost of an action may be preconfigured, e.g. by a health practitioner, or the learning function may learn the time-dependencies. That is, the learning function may learn that that certain actions have a greater reward and/or cost if performed at one stage compared to another stage.

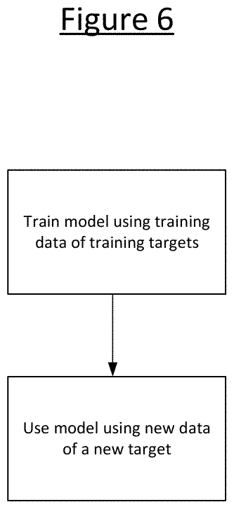

The sequential model 208′ may be trained using the data of many different training targets. The model may then be used to determine one or more actions to take in relation to a new target in order to achieve a desired outcome for the new target. This is illustrated schematically in FIG. 6.

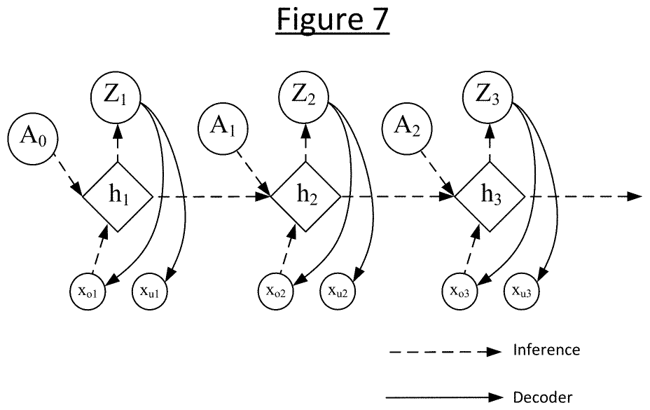

FIG. 7 illustrates another schematic representation of the sequential model 208′. In this Figure, the model is expanded to show hidden states of the model. As shown, at each stage the action(s) and partial observation(s) are used to infer a hidden state in a deterministic manner, which is then used to infer a latent space representation in a probabilistic manner. That is, h₁ is deterministically derived from A₀ and Xₒ₀, and then h₁ is used to generate a probabilistic representation of Z₁. The nature of the hidden states is described in more detail below.

The trained sequential model 208′ may be employed to predict actions to take to improve the condition of a user, such as to treat a disease or other health condition. For example, once trained, the model may receive the answers to questions presented to a user about their health status to provide data to the model. A user interface may be provided to enable questions to be output to a user and to receive responses from a user for example through a voice or other interface means. In some example, the user interface may comprise a chatbot. In other examples, the user interface may comprise a graphical user interface (GUI) such as a point and click user interface or a touch screen user interface. The trained algorithm may be configured to use the user responses, which provide his or her health data, to predict actions to take to improve the user's condition. In some embodiments, the model can be used to recommend actions to take to improve the user's health (e.g. an action may be to provide the user with a certain medicine). A user's condition may be monitored by asking questions which are repeated instances of the same question (asking the same thing, i.e. the same question content), and/or different questions (asking different things, i.e. different question content). The questions may relate to a condition of the user in order to monitor that condition. For example, the condition may be a health condition such as asthma, depression, fitness etc. User data may also be provided from sensor devices, e.g. a wearable or portable sensor device worn or carried about the user's person. For example, such a device could take the form of an inhaler or spirometer with embedded communication interface for connecting to a controller and supplying data to the controller. Data from the sensor may be input to the model and form part of the patient data for using the model to make predictions.

Contextual metadata may also be provided for training and using the algorithm. Such metadata could comprise a user's location. A user's location could be monitored by a portable or wearable device disposed about the user's person (plus any one or more of a variety of known localisation techniques such as triangulation, trilateration, multilateration or finger printing relative to a network to known nodes such WLAN access points, cellular base stations, satellites or anchor nodes of a dedicated positioning network such an indoor location network). Other contextual information such as sleep quality may be inferred from personal device data, for example by using a wearable sleep monitor. In further alternative or additional examples, sensor data from e.g. a camera, localisation system, motion sensor and/or heart rate monitor can be used as metadata.

The model 208′ may be trained to treat a particular disease or achieve a particular health condition. For example, the model may be used to treat a certain type of cancer or diabetes based on training data of previous patients. Once a model has been trained, it can be utilised to provide a treatment plan for that particular disease when patient data is provided from a new patient.

Another example of use of the model 208′ is to take actions in relation to a machine, such as in the field of oil drilling. The data supplied may relate to geological conditions. Different sensors may be utilised on a tool at a particular geographic location. The sensors could comprise for example radar, lidar and location sensors. Other sensors such as the thermometers or vibration sensors may also be utilised. Data from the sensors may be in different data categories and therefore constitute mixed data. Once the model has been effectively trained on this mixed data, it may be applied in an unknown context by taking sensor readings from equivalent sensors in that unknown context and used to make drilling-related decisions, e.g. to change parameters of the drill such as drilling power, depth, etc.

A possible further application is in the field of self-driving cars, where decisions are made during driving. In that case, data may be generated from sensors such as radar sensors, lidar sensors and location sensors on a car and used as a feature set to train the model to take certain actions based on the condition that the car may be in. Once a model has been trained, a corresponding mixed data set may be provided to the model to predict certain actions, e.g. increase/decrease speed, change heading, brake, etc.

A further possible application of the trained model 208′ is in machine diagnosis and management in an industrial context. For example, readings from different machine sensors including without limitation, temperature sensors, vibration sensors, accelerometers, fluid pressure sensors may be used to train the model for preventative maintenance. Once a model has been trained, it can be utilised to predict actions to take to maintain the machine in a desired state, e.g. to ensure the machine is operable for a desired length of time. In this context, an action may be to decrease a load on a machine, or replace a component of the machine, etc.

The following describes a particular implementation of the present invention using experimental data.

Problem Setting

This section formalizes the problem setting, i.e., jointly learning the task and feature acquisition policy. To this end, we define the active feature acquisition POMDP, a rich class of discrete-time stochastic control processes generalizing standard POMDPs:

Definition 1 (AFA-POMDP). The active feature acquisition POMDP is a tuple [symbol] = [symbol] , where [symbol] is the state space and [symbol] = [symbol] ^{c}× [symbol] is a joint action space of feature acquisition actions [symbol] and control actions [symbol] ^{c}. The transition kernel [symbol] : [symbol] × [symbol] ^{c}× [symbol] → [symbol] maps any joint action a=(a^{c}, a^{f}) in state s∈ [symbol] to a distribution [symbol] over next states. In each state s, the agent observes the features x^{p} which are a subset of the features x=(x^{p},x^{u})˜ [symbol] (s) selected by the agent taking feature acquisition action a^{f}, where [symbol] (s) is a distribution over possible feature observation for state s and x^{u} are features not observed by the agent. When taking a joint action, the agent obtains rewards according to the reward function [symbol] : [symbol] × [symbol] ^{c}→ [symbol] and pays a cost of [symbol] : [symbol] × [symbol] → [symbol] for feature acquisition. Rewards and costs are discounted by the discount factor γ∈[0,1).

Simplifying Assumptions

For simplicity, we assume that x consists of a fixed number of features N_{f} for all states, that [symbol] =2^{[N}^{_{f}}^{]} is the powerset of all the N_{f} features, and that \x^{p}(a^{f}) consists of all the features in x indicated by the subset a^{f}∈ [symbol] . Note that the feature acquisition action for a specific application can take various different forms. For instance, in our experiments below, for the Sepsis task, we define feature acquisition as selecting a subset over possible measurement tests, whereas for the Bouncing Ball⁺ task, we divide an image into four observation regions and let the feature acquisition policy select a subset of observation regions (rather than raw pixels). Please also note that while in a general AFA-POMDP, the transition between two states depends on the joint action, we assume in the following that it depends only on the control action, i.e., [symbol] (s, a^{c}, a^{f′})= [symbol] (s, a^{c}, a^{f}) for all a^{f′}, a^{f}∈ [symbol] . While not true for all possible applications, this assumption can be a reasonable approximation for instance for medical settings in which tests are non-invasive. For simplicity we furthermore assume that acquiring each feature has the same cost, denoted as c, i.e., [symbol] (a^{f}, s)=c|a^{f}|, but our approach can be straightforwardly adapted to have different costs for different feature acquisitions.

Objective

We aim to learn a policy which trades off reward maximization and the cost for feature acquisition by jointly optimizing a task policy π^{c} and a feature acquisition policy π^{f}. That is, we aim to solve the optimization problem

$${max}_{{π}^{f} , {π}^{c}} 𝔼 [ {\sum }_{t = 0}^{∞} {γ}^{t} ( ℛ ( {s}_{t} , {a}_{t}^{c} ) - {{\sum }^{\vert {f}_{} \vert}}_{i} c \cdot ( {a}_{t}^{f ( i )} ) ) ] ,$$

where the expectation is over the randomness of the stochastic process and the policies, sₜ is the state of the system at time r, aₜ^{f(i)} denotes the i-th feature acquisition action at time t, and [symbol] (⋅) is an indicator function whose value equals to 1 if that feature has been acquired. Note that the above optimization problem is very challenging: an optimal solution needs to maintain beliefs bₜ over the state of the system at time t which is a function of partial observations obtained so far. Both the feature acquisition policy π^{f}(aₜ^{f}|bₜ) and the task policy π^{c}(aₜ^{c}|bₜ) depend on this belief. The information in the belief itself can be controlled by the feature acquisition policy through querying subsets from the features xt and hence the task policy and feature acquisition policy itself strongly depend on the effectiveness of the feature acquisition.

Through enabling to query subsets of observations, the feature acquisition action space [symbol] is exponential in the number of features.

Remarks

Clearly, any AFA-POMDP corresponds to a POMDP in which the reward is defined appropriately from [symbol] and [symbol] and observations depend on the taken joint action. In principle this provides a natural way for approaching AFA-POMDPs: map them to the corresponding POMDP and (approximately) solve this POMDP using any suitable method. There is however an additional challenge because of the exponential size of the feature acquisition state space. In many practical applications this explosion, however, is not that severe. For instance in many medical applications, there are only a few costly or dangerous measurements while other information like demographics or a person's temperature are available at essentially no cost. General scaling of RL to large action spaces is an interesting and active research topic orthogonal to our work. Studying hierarchical representations of the measurements for feature selection in the context of AFA-POMDPs, which can likely alleviate issues due to the large action space, are subject to future work.

Sequential Representation Learning with Partial Observations

We introduce a sequential representation learning approach to facilitate the task of policy training with active feature acquisition. Let x_{1:T}=(x₁, . . . , x_{T}) and a_{1:T}=(a₁, . . . , a_{T}) denote a sequence of observations and actions, respectively. Alternatively, we also denote these sequences as x_{≤T} and a_{≤T}. Overall, our task of interest is to train a sequential representation learning model to learn the distribution of the full sequential observations x_{1:T}, i.e., for both the observed part x_{1:T}^{p} and the unobserved part x_{1:T}^{u}. Given only partial observations, we can perform inference only with the observed features x_{1:T}^{p}. Therefore, our proposed approach extends the conventional unsupervised representation learning task to a supervised learning task, which learns to impute the unobserved features by synthesizing the acquired information and learning the model dynamics.

As such, the key underlying assumption is that learning to impute the unobserved features would result in better representations which can be leveraged by the task policy. And performing sequential representation learning, as we propose, is a more adequate choice than non-sequential modeling, for our task of interest with partial observability. Furthermore, unlike many conventional sequential representation learning models for reinforcement learning that only reason over the observation sequence x_{1:T}^{p}, in our work, we take into account both the observation sequence x_{1:T}^{p} and the action sequence a_{1:T} for conducting inference. The intuition is that since x_{1:T}^{p} by itself consists of very limited information over the agent's underlying MDP state, incorporating the action sequence would be an informative add-on to the agent's acquired information to infer the belief state. To summarize, our proposed sequential representation model learns to encode x_{1:T}^{p} and a_{1:T} into meaningful latent features, for predicting x_{1:T}^{p} and x_{1:T}^{u}. The architecture of our proposed sequential representation learning model is shown in FIG. 7.

Observation Decoder

Let z_{1:T}=(z₁, . . . , z_{T}) denote a sequence of latent states. We consider the following probabilistic model:

$${p}_{θ} ( {x}_{1 : T}^{p} , {x}_{1 : T}^{u} , {z}_{1 : T} ) = {\prod }_{t = 1}^{T} p ( {x}_{t}^{p} , {x}_{t}^{u} \vert {z}_{t} ) p ( {z}_{t} ) ,$$

For simplicity of the notations, we assume z₀=0. We impose a simple prior distribution over z, i.e., a standard Gaussian prior, instead of incorporating some learned prior distribution over the latent space of z, such as an autoregressive prior distribution like p(zₜ|zₜ₋₁, x_{1:t}^{p}, a_{0:t-1}). The reason is that using a static prior distribution results in latent representation zₜ that is stronger regularized and more normalized than using a learned prior distribution which is stochastically changing over time. This is crucial for deriving stable policy training performance. At time t, the generation of data xₜ^{p} and xₜ^{u} depends on the corresponding latent variable zₜ. Given zₜ, the observed variables are conditionally independent of the unobserved ones. Therefore,

p(xₜ^{p},xₜ^{u}|zₜ)=p(xᵣ^{p}|zₜ)p(xₜ^{u}|zₜ).

Belief Inference Model

During policy training we only assume access to partially observed data. This requires an inference model which takes in the past observation and action sequences to infer the latent states z. Specifically, we present a structured inference network q_{ϕ} as shown in FIG. 7, which has an autoregressive structure:

$${q}_{ϕ} ( {z}_{1 : T} \vert {x}_{1 : T} , {a}_{< T} ) = {\prod }_{t = 1}^{T} {q}_{ϕ} ( {z}_{t} \vert \backslash {x}_{\leq t}^{p} , {a}_{< t} ) ,$$

where q_{ϕ}(⋅) is a function that aggregates the filtering posteriors of the history of observation and action sequences. Following the common practice in existing sequential VAE literature, we adopt a forward RNN model as the backbone for the filtering function q_{ϕ}(⋅). Specifically, at step t, the RNN processes the encoded partial observation xₜ^{p}, action aₜ₋₁ and its past hidden state hₜ₋₁ to update its hidden state ht. Then the latent distribution zₜ is inferred from hₜ. The belief state bₜ is defined as the mean of the distribution zₜ. By accomplishing the supervised learning task, the belief state could provide abundant information for not only the observed sequential features, but also for the missing features, so that the policy trained over it could benefit from it and progress faster towards getting better convergent performance.

Learning

We proposed to pre-train both the generative and inference models offline before learning the RL policies. In this case, we assume the access to the unobserved features, so that we can construct a supervised learning task to learn to impute unobserved features. Concretely, the pre-training task update the parameters θ, ϕ by maximizing the following variational lower-bound:

$$log p ( {x}_{1 : T}^{p} , {x}_{1 : T}^{u} ) \geq {E}_{{q}_{ϕ}} [ {\sum }_{t} log {p}_{θ} ( {x}_{t}^{p} \vert {z}_{t} ) + log {p}_{θ} ( {x}_{t}^{u} \vert ∖ {z}_{t} ) - KL ( {q}_{ϕ} ( {z}_{t} \vert {x}_{\leq t}^{p} , {a}_{< t} ) \vert \vert p ( {z}_{t} ) ) ] = ELBO ( {x}_{1 : T}^{p} , {x}_{1 : T}^{u} ) .$$

By incorporating the term log p_{θ}(xₜ^{u}|zₜ), the training of sequential VAE generalizes from an unsupervised task to a supervised task that learns the model dynamics from past observed transitions and imputes the missing features. Given the pre-trained representation learning model, the policy is trained under multi-stage reinforcement learning setting, where the representation provided by sequential VAE is taken as the input to the policy.

Experiments

We examine the characteristics of our proposed model in the following two experimental domains: a bouncing ball control task with high-dimensional image pixels as input; and a sepsis medical simulator fitted from real-world data.

Baselines

For comparison, we mainly consider variants of the strong VAE baseline beta-VAE, which works on non-time-dependent data instances. For representing the missing features, we adopt a zero-imputing method over the unobserved features. Thus, we denote the VAE baseline as NonSeq-ZI. We train the VAE with either the full loss over the entire features, or the partial loss which only applies to the observed features. We also consider an end-to-end baseline which does not employ pre-trained representation learning model. We denoted our proposed sequential VAE model for POMDPs as Seq-PO-VAE. All the VAE-based approaches adopt an identical policy architecture. Detailed information on the model architecture is presented in appendix. We conduct all the experiments with 10 random seeds.

Data Collection

Pre-training the VAE models requires data generated by a non-random policy in order to incorporate abundant dynamics information. For both tasks, we collect a small scale dataset of 2000 trajectories, where half of the data is collected from a random policy and the other half from a policy which better captures the state space that would be encountered by a learned model (e.g., by training a data collection policy end-to-end or using human generated trajectories). The simple mixture of dataset works very well on both tasks without the need of further fine-tuning the VAEs. We also create a testing set that consists of 2000 trajectories to evaluate the models.

Bouncing Ball⁺

Task Settings

The conventional bouncing ball experiment is adapted by adding a navigation objective and introducing control actions. Specifically, a ball moves in a 2D box and at each step, a binary image of size 32×32 showing the box and the ball is returned as the state. Initially, the ball appears at a random position in the upper left quadrant, and has a random velocity. The objective is to control the ball to reach a fixed target location set at (5, 25). We incorporate five RL actions: a null action and four actions for changing the velocity of the ball in either the x (horizontal) or y (vertical) direction with a fixed scale: {ΔVₓ: ±0.5, ΔV_{y}: ±0.5, null}. The feature acquisition action is defined as selecting a subset from the four quadrants of image to observe. A reward of 1.0 is issued if the ball reaches its target location. Each episode runs up to 50 time steps.

Representation Learning Results

We evaluate the missing feature imputing performance of each VAE model in terms of negative log likelihood (NLL) and present results in the table below. We notice that our proposed model yields a significantly better imputing result than all the other baselines. This demonstrates that our proposed sequential VAE model can efficiently capture the environment dynamics and learn meaningful information over the missing features. Such efficiency is important in determining both the acquisition and task policy training performance in AFA-POMDP, since both policies are conditioned on the VAE latent features. We also demonstrate sample trajectories reconstructed by different VAE models in the Appendix. The result shows that our model learns to impute significant amount of missing information given the partially observed sequence.

| VAE Model | Bouncing Ball (NLL) | Sepsis (MSE) |
|---|---|---|
| NonSeq-ZI (Partial) | 0.6504 (±0.1391) | 0.8441 (±0.0586) |
| NonSeq-ZI (Full) | 0.0722 (±0.0004) | 0.4839 (±0.0012) |
| Seq-PO-VAE (Ours) | 0.0324 (±0.0082) | 0.1832 (±0.0158) |

Policy Training Results

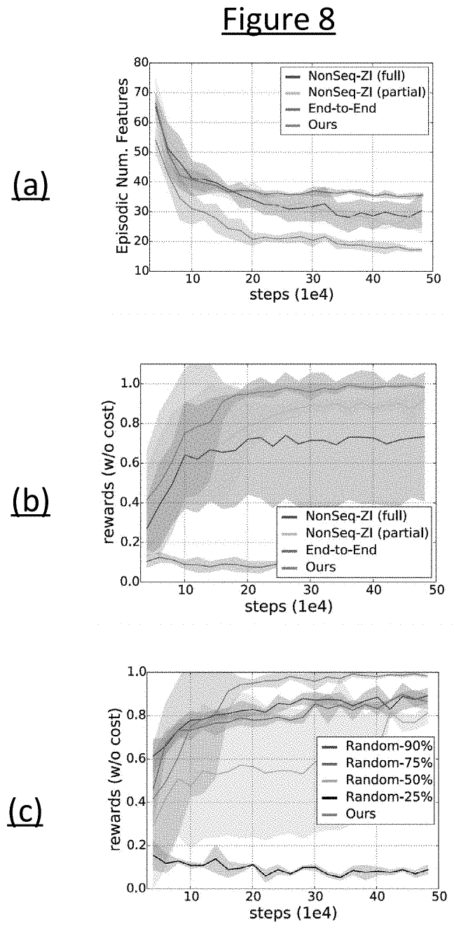

We evaluate the policy training performance in terms of episodic number of acquired observations and the task rewards (w/o cost). The results are presented in FIGS. 8 (a) and (b), respectively. First, we notice that the end-to-end method fails to learn task skills under the given feature acquisition cost. However, the VAE-based representation learning methods manage to learn the navigation skill under the same cost setting. This verifies our assumption that representation learning could bring significant benefit to the policy training under the AFA-POMDP scenario. Furthermore, we also notice that the joint policies trained by Seq-PO-VAE can develop the target navigation skill at a much faster pace than the non-sequential baselines. Our method also converges to a standard where much less feature acquisition is required to perform the task.

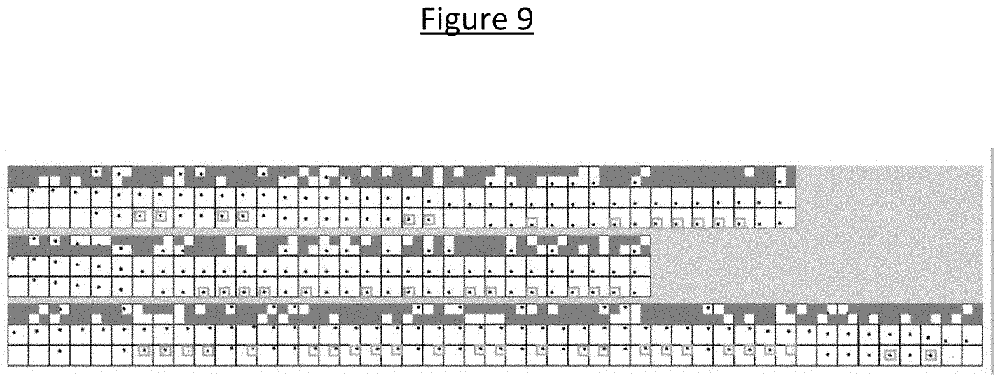

We also show that our proposed method can learn meaningful feature acquisition policies. To this end, we visualize three sampled trajectories upon convergence of training in FIG. 9. From the examples, we notice that our feature acquisition policy acquires meaningful features with a majority grasping the exact ball location. Thus, it demonstrates that the feature acquisition policy adapts to the dynamics of the problem and learns to acquire meaningful features. We also show the actively learned feature acquisition policy works better than random acquisition. From the results in FIG. 8 (c), our method converges to substantially better standard than random policies with considerably high selection probabilities.

FIG. 9 shows Seq-PO-VAE reconstruction for the online trajectories upon convergence (better to view enlarged). Each block of three rows corresponds to the results for one trajectory. In each block, the three rows (top-down) correspond to: (1) the partially observable input selected by acquisition policy; (2) the ground-truth full observation; (3) reconstruction from Seq-PO-VAE. The green boxes remark the frames where ball is not observed but our model could impute its location. Key takeaways: (1) our learned acquisition policy captures model dynamics; (2) Seq-PO-VAE effectively impute the missing features (i.e., ball can be reconstructed even when they are unobserved from consequent frames).

Sepsis Medical Simulator

Task Setting

Our second evaluation domain is a medical simulator for treating sepsis among ICU patients. Overall, the task is to learn to apply three treatment actions to the patient, i.e, {antibiotic, ventilation, vasopressors}. The state space consists of 8 features: 3 of them indicate the current treatment state for the patient; 4 of them are the measurement states over heart rate, sysBP rate, percoxyg state and glucose level; the rest is an index specifying the patent's diabetes condition. The feature acquisition policy learns to actively select the measurement features. Each episode runs for up to 30 steps. The patient will be discharged if his/her measurement states all return to normal values. An episode terminates upon mortality or discharge, with a reward −1.0 or 1.0.

Representation Learning Result

We evaluate the imputation performance for each VAE model on the testing dataset. The loss is evaluated in terms of MSE, presented in the table above. Our model results in the lowest MSE loss. Again this result shows that the sequential VAE could learn reasonable imputation over missing features with the learned model dynamics on tasks with stochastic transitions.

Policy Training Result

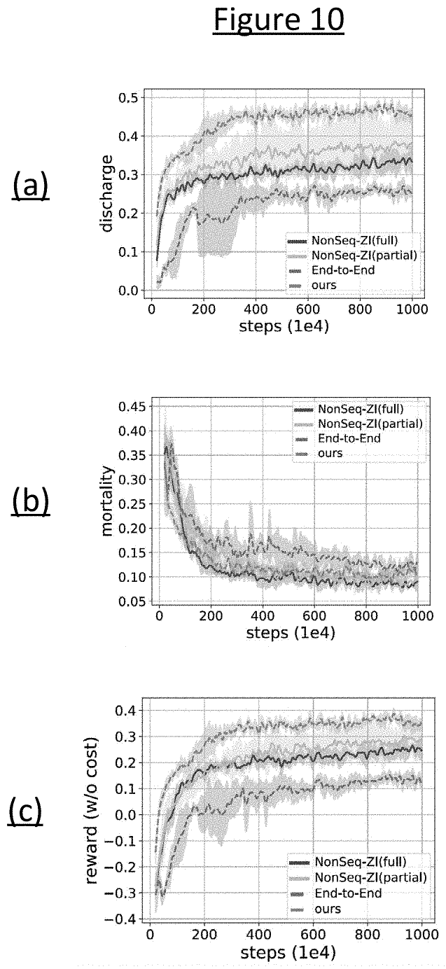

We show the policy training results for Sepsis in FIG. 10. Overall, our proposed method results in substantially better task reward compared to all baselines. Note that the performance of discharge rate for our method increases significantly faster than baseline approaches, which shows that the model can quickly learn to apply appropriate treatment actions and thus be trained in a much more sample efficient way. Moreover, our method also converges to substantially better values than the baselines. Upon convergence, it outperforms the best non-sequential VAE baseline with a gap of >5% for discharge rate. For all the evaluation metrics, we notice that VAE-based representation learning models outperform the end-to-end baseline by significant margins. This indicates that efficient representation learning is crucial to determine the effect of agent's policy training practice.

The result also reveals that learning to impute missing features has the potential to contribute greatly to improve the policy training performance for AFA-POMDP.

Efficacy of Active Feature Acquisition

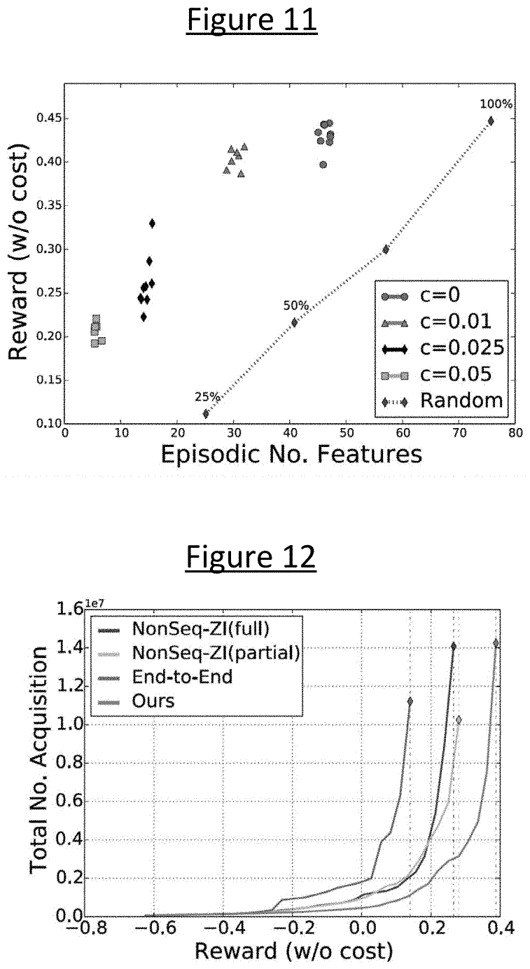

We study the effect of actively learning sequential feature acquisition strategy with RL. To this end, we compare our method with a baseline that randomly acquires features. We evaluate our method under different cost values, and the results are shown in FIG. 11. From the results, we notice that there is a clear cost-performance trade-off, i.e., a higher feature acquisition cost results in feature acquisition policies that obtain fewer observations, with a sacrifice of task performance. Overall, our acquisition method results in significantly better task performance than the random acquisition baselines. Noticeably, with the learned active feature acquisition strategy, we acquire only about half of the total number of features (refer to the x-value derived by Random-100%) to obtain comparable task performance.

Impact on Total Acquisition Cost

For different representation learning methods, we also investigate the total number of features acquired at different stage of training. The results are shown in FIG. 12. As expected, to obtain better task policies, the models need to take longer training steps and thus the total feature acquisition cost would increases accordingly. We notice that policies trained by our method result in the highest convergent task performance (max x-value). Given a certain performance level (same x-value), our method consumes substantially less total feature acquisition cost (y-value) than the others. We also notice that the overall feature acquisition cost increases with a near exponential trend. Overall, conducting policy training for AFA-POMDP with our proposed representation learning method could lead to subsequent reduce in total feature acquisition cost compared to the baseline methods.

### CONCLUSION

A novel AFA-POMDP framework is presented where the task policy and the active feature acquisition strategy are learned under a unified formalism. Our method incorporates a model-based representation learning attempt, where a sequential VAE model is trained to impute missing features via learning model dynamics and thus offer high quality representations to facilitate the joint policy training under partial observability. Our proposed model, by efficiently synthesizing the sequential information and imputing missing features, can significantly outperform conventional representation learning baselines and leads to policy training with significantly better sample efficiency and obtained solutions. Future work may investigate more cost-sensitive application domains to apply our proposed method. Another promising direction is to integrate our framework with model-based planning for further reducing the feature acquisition cost.

When deploying machine learning models in real-world applications, the fundamental assumption that the features used during training are always readily available during the deployment phase does not necessarily hold. Our proposed approach could relax such assumptions and enable machine learning models to be used in a broader range of application domains.

The present invention also opens an interesting new research direction for active learning, which extends the conventional instance-wise non-time-dependent active feature acquisition task to a more challenging time-dependent sequential decision making task. This task has important implications for real-life applications, such as healthcare and education. We demonstrate the great potential and practicality of deriving cost-sensitive decision making strategies with active learning.

Considering that learning and applying the models is problem specific, it is unlikely that our method can equally benefit all possible application scenarios. We also fully acknowledge the existence of risk in applying our model in sensitive and high risk domains, e.g., healthcare, and bias if the model itself or the used representations are trained on biased data. In high risk settings, human supervision of the proposed model might be desired and the model could mainly be used for decision support. However, there are still many practical scenarios that could satisfy our model assumption and are less sensitive.

It will be appreciated that the above embodiments have been described by way of example only.

More generally, according to one aspect disclosed herein, there is provided a computer-implemented method of training a model comprising a sequence of stages from a first stage to a last stage in the sequence, the model being trained based on i) a set of real-world features of a feature space associated with a target that are available for observation, and ii) a set of actions that are available to apply to the target, wherein the set of actions comprises observing at least one of the set of real-world features, and/or performing at least one task in order to affect a status of the target, wherein the model is trained to achieve a desired outcome, and wherein:
each stage in the sequence comprises:
   a variational auto-encoder, VAE, comprising a respective first encoder arranged to encode a respective subset of the real-world features into a respective latent space representation, and a respective first decoder arranged to decode from the respective latent space representation to a respective decoded version of the respective set of real-world features;
at least each but the last stage in the sequence comprises:
   a respective second decoder arranged to decode from the respective latent space representation to predict one or more respective actions; and
each successive stage in the sequence following the first stage, each succeeding a respective preceding stage in the sequence, further comprises:
   a sequential network arranged to transform from the latent representation from the preceding stage to the latent space representation of the successive stage.

In embodiments, the sequential network may also be referred to a latent space linking network—it is a network arranged to link one latent space representation to another in the sequence, i.e. to map from a preceding latent space representation to a succeeding latent space representation.

In embodiments, each stage in the sequence may comprise a respective second decoder. In some embodiments, each stage other than a final stage in the sequence comprises a respective second decoder.

In embodiments, each stage in the sequence may comprise a respective VAE and a respective second decoder. Each VAE is configured to encode and decode the relevant data at a certain point in a sequence, e.g. a certain point in time. That is, a first VAE in the sequence has access to a subset of features that have been observed at a first stage, and based on those features learns a mapping to the full feature space (i.e. the set of observed and unobserved features). The first VAE uses the information available at that stage to infer a latent space representation at that stage. The second decoder is configured to predict (i.e. select) a first action to take. Preferably each VAE is a partially-observed VAE in the sense that only some but not all of the features are observed (i.e. received) at any given stage.

In embodiments, from the second stage onwards, each stage may include a respective second encoder and a respective sequential network. The second encoder uses the action(s) predicted action of the previous stage to infer the latent space representation of the present stage. The sequential network transforms (i.e. maps) from the previous latent space representation to the present latent space representation of the present stage.

In embodiments, at least one of the successive stages in the sequence may comprises:
a respective second encoder arranged to encode from the one or more predicted actions of the preceding stage into the latent space representation of the successive stage.

For instance, the at least one successive stage is a final one of the successive stages in the sequence. In some embodiments, more than one of the successive stages, e.g. each of the successive stages, comprises a respective second encoder.

In embodiments, only the one or more predicted task(s) of the preceding stage are encoded into the latent space representation of the successive stage.

In embodiments, at least one of the successive stages may comprise a respective third encoder arranged to encode from the latent representation of said one of the stages to a respective representation of a present status of the target, and/or wherein the model comprises a final third encoder arranged to encoder from the respective latent space representation of a final one of the successive stages to a predicted outcome of the model.

In embodiments, the sequence has a final stage. The final stage may encode to a representation of the final status of the target.

In embodiments, the method may comprise outputting, to a user interface, the respective representation of the present status of the target at one, some or each of the successive stages.

I.e. the present status is output to a user, e.g. a health practitioner.

In embodiments, the respective first encoder of at least one successive stage may be arranged to encode to the respective latent space representation of that stage from the respective decoded version of the respective set of real-world features of one or more different stages.

That is, the decoded data from one or more stages may be used (or rather, may be “re-used”) at a different stage in the sequence.

In embodiments, at least one of the one or more different stages may be positioned before the at least one successive stage in the sequence, and/or wherein at least one of the one or more different stages is positioned after the at least one successive stage in the sequence.

In embodiments, the respective second decoder of each stage may be trained to predict the one or more respective actions based on a learning function, wherein the learning function comprises a reward function that is a function of the predicted outcome.

In embodiments, the learning function may be configured to jointly optimizing a task policy for task selection and a feature acquisition policy for acquiring (i.e. observing) features.

In embodiments, the learning function may comprise a penalty function that is a function of a respective cost of the one or more predicted actions.

In embodiments, the respective effect and/or cost of some or all of the set of actions may be time-dependent.

That is, the reward and/or cost of performing an action may be dependent on the time at which said task is performed.

In embodiments, the target may be a living being, wherein the set of real-world features comprise characteristics of the living being, and wherein the desired status is a status of the human being's health.

In embodiments, the living being may be a human being.

In embodiments, one or more of the characteristics of the human being may be based on sensor measurements of the living being and/or survey data supplied by or on behalf of the human being.

In embodiments, the target may be a machine, wherein the set of real-world features comprise characteristics of the machine and/or an object that the machine is configured to interact with.

According to another aspect disclosed herein, there is provided a method of using the model of any of the described embodiments to determine, for a new target, a sequence of one or more actions to apply to the new target in order to achieve a desired status of the new target.

Another aspect provides a computer program embodied on computer-readable storage and configured so as when run on one or more processing units to perform the method of any of the aspects or embodiments hereinabove defined.

Another aspect provides a computer system comprising:
memory comprising one or more memory units, and
processing apparatus comprising one or more processing units;
wherein the memory stores code arranged to run on the processing apparatus, the code being configured so as when run on the processing apparatus to carry out the method of any of the aspects or embodiments hereinabove defined.

In embodiments, the computer system is implemented as a server comprising one or more server units at one or more geographic sites, the server arranged to perform one or both of:
gathering observations of said features from a plurality of devices over a network, and using the observations to perform said training; and/or
providing prediction or imputation services to users, over a network, based on the trained model.

In embodiments the network for the purpose of one or both of these services may be a wide area internetwork such as the Internet. In the case of gathering observations, said gathering may comprise gathering some or all of the observations from a plurality of different targets through different respective user devices. As another example said gathering may comprise gathering some or all of the observations from a plurality of different sensor devices, e.g. IoT devices or industrial measurement devices.

Other variants or use cases of the disclosed techniques may become apparent to the person skilled in the art once given the disclosure herein. The scope of the disclosure is not limited by the described embodiments but only by the accompanying claims.

1. A computer-implemented method of training a model comprising a sequence of stages from a first stage to a last stage in the sequence, the model being trained based on i) a set of real-world features of a feature space associated with a target that are available for observation, and ii) a set of actions that are available to apply to the target, wherein the set of actions comprises observing at least one of the set of real-world features, and/or performing at least one task in order to affect a status of the target, wherein the model is trained to achieve a desired outcome, and wherein:
each stage in the sequence comprises:
a variational auto-encoder, VAE, comprising a respective first encoder arranged to encode a respective subset of the real-world features into a respective latent space representation, and a respective first decoder arranged to decode from the respective latent space representation to a respective decoded version of the respective set of real-world features;
at least each but the last stage in the sequence comprises:
a respective second decoder arranged to decode from the respective latent space representation to predict one or more respective actions; and
each successive stage in the sequence following the first stage, each succeeding a respective preceding stage in the sequence, further comprises:
a sequential network arranged to transform from the latent representation from the preceding stage to the latent space representation of the successive stage.

2. The method of claim 1, wherein at least one of the successive stages in the sequence comprises:
a respective second encoder arranged to encode from the one or more predicted actions of the preceding stage into the latent space representation of the successive stage.

3. The method of claim 1, wherein at least one of the successive stages comprises a respective third encoder arranged to encode from the latent representation of said one of the stages to a respective representation of a present status of the target, and/or wherein the model comprises a final third encoder arranged to encoder from the respective latent space representation of a final one of the successive stages to a predicted outcome of the model.

4. The method of claim 3, comprising outputting, to a user interface, the respective representation of the present status of the target at one, some or each of the successive stages.

5. The method of claim 3, wherein the respective second decoder of each stage is trained to predict the one or more respective actions based on a learning function, wherein the learning function comprises a reward function that is a function of the predicted outcome.

6. The method of claim 5, wherein the learning function comprises a penalty function that is a function of a respective cost of the one or more predicted actions.

7. The method of claim 1, wherein the respective first encoder of at least one successive stage is arranged to encode to the respective latent space representation of that stage from the respective decoded version of the respective set of real-world features of one or more different stages.

8. The method of claim 7, wherein at least one of the one or more different stages is positioned before the at least one successive stage in the sequence, and/or wherein at least one of the one or more different stages is positioned after the at least one successive stage in the sequence.

9. The method of claim 1, wherein the respective effect and/or cost of some or all of the set of actions is time-dependent.

10. The method of claim 1, wherein the target is a living being, wherein the set of real-world features comprise characteristics of the living being, and wherein the desired status is a status of the human being's health.

11. The method of claim 10, wherein the living being is a human being, and wherein one or more of the characteristics of the human being are based on sensor measurements of the living being and/or survey data supplied by or on behalf of the human being.

12. The method of claim 1, wherein the target is a machine, wherein the set of real-world features comprise characteristics of the machine and/or an object that the machine is configured to interact with.

13. A method of using the model of claim 1, for a new target, a sequence of one or more actions to apply to the new target in order to achieve a desired status of the new target.

14. A computer program embodied on computer-readable storage and configured so as when run on one or more processing units to perform a method of training a model comprising a sequence of stages from a first stage to a last stage in the sequence, the model being trained based on i) a set of real-world features of a feature space associated with a target that are available for observation, and ii) a set of actions that are available to apply to the target, wherein the set of actions comprises observing at least one of the set of real-world features, and/or performing at least one task in order to affect a status of the target, wherein the model is trained to achieve a desired outcome, and wherein:
each stage in the sequence comprises:
a variational auto-encoder, VAE, comprising a respective first encoder arranged to encode a respective subset of the real-world features into a respective latent space representation, and a respective first decoder arranged to decode from the respective latent space representation to a respective decoded version of the respective set of real-world features;
at least each but the last stage in the sequence comprises:
a respective second decoder arranged to decode from the respective latent space representation to predict one or more respective actions; and
each successive stage in the sequence following the first stage, each succeeding a respective preceding stage in the sequence, further comprises:
a sequential network arranged to transform from the latent representation from the preceding stage to the latent space representation of the successive stage.

15. A computer system comprising:
memory comprising one or more memory units, and
processing apparatus comprising one or more processing units;
wherein the memory stores code arranged to run on the processing apparatus, the code being configured so as when run on the processing apparatus to carry out a method of training a model comprising a sequence of stages from a first stage to a last stage in the sequence, the model being trained based on i) a set of real-world features of a feature space associated with a target that are available for observation, and ii) a set of actions that are available to apply to the target, wherein the set of actions comprises observing at least one of the set of real-world features, and/or performing at least one task in order to affect a status of the target, wherein the model is trained to achieve a desired outcome, and wherein:
each stage in the sequence comprises:
a variational auto-encoder, VAE, comprising a respective first encoder arranged to encode a respective subset of the real-world features into a respective latent space representation, and a respective first decoder arranged to decode from the respective latent space representation to a respective decoded version of the respective set of real-world features;
at least each but the last stage in the sequence comprises:
a respective second decoder arranged to decode from the respective latent space representation to predict one or more respective actions; and
each successive stage in the sequence following the first stage, each succeeding a respective preceding stage in the sequence, further comprises:
a sequential network arranged to transform from the latent representation from the preceding stage to the latent space representation of the successive stage.
